(19) United States
(12) Patent Application Publication
(10) Pub. No.: US 2016/0097931 A1
(43) Pub. Date: Apr. 7, 2016

(54) DISPLAY DEVICE AND LIGHT SOURCE FOR IMAGE DISPLAY DEVICE

(71) Applicant: SONY CORPORATION, Tokyo (JP)

(72) Inventors: Noriyoshi Takahota, Kanagawa (JP); Eiji Kato, Kanagawa (JP); Takashi Hirakawa, Tokyo (JP)

(73) Assignee: Sony Corporation, Tokyo (JP)

(21) Appl. No.: 14/889,502

(22) PCT Filed: May 12, 2014
(86) PCT No.: PCT/JP2014/002492

§ 371 Date: Nov. 6, 2015

(30) Foreign Application Priority Data
May 15, 2013 (JP) 2013-102794

(51) Int. Cl. G02B 27/01; G09G 3/20

(52) U.S. Cl. CPC G02B 27/0172; G09G 3/2018; G09G 2310/0235; G02B 2027/0112; G02B 2027/0132; G02B 2027/0178; G02B 2027/014

(57) ABSTRACT

A display device including a first image forming device and a second image forming device. The first image forming device is configured to form a first color image by sequentially displaying a first plurality of single color images according to a first color sequence. The second image forming device is configured to form a second color image by sequentially displaying a second plurality of single color images according to a second color sequence. The first color sequence is different from the second color sequence.

### CROSS REFERENCE TO RELATED APPLICATIONS

This application claims the benefit of Japanese Priority Patent Application JP 2013-102794 filed May 15, 2013, the entire contents of which are incorporated herein by reference.

### TECHNICAL FIELD

The present disclosure relates to a display device, and more specifically, a display device applicable for use in a head mounted display (HMD), and a light source for an image display device applicable for use in the related display device.

### BACKGROUND ART

PTL 1, for example, discloses a virtual image display device (display device) configured so that a viewer may view a two-dimensional image formed by an image forming device as a virtual image enlarged by a virtual image optical system.

As illustrated in the schematic in FIG. 21, a display device 100′ is provisioned with an image forming device 111′ including multiple pixels arranged in a two-dimensional matrix, a collimate optical system 112 configured to collimate light emitted from pixels in the image forming device 111′ into parallel light, and an optical device (light guiding unit) 120 configured to guide light illuminated as parallel light by the collimate optical system 112 and emit this to a pupil 21 of the viewer. The optical device 120 is configured including a light guide board 121 to which illuminated light is emitted after propagation by total reflection of the interior, a first deflector 130 (formed, for example, from one layer of a light reflecting coating) configured to reflect light illuminated onto the light guide board 121 so that the light illuminated onto the light guide board 121 is completely reflected to the interior of the light guide board 121, and a second deflector 140 (formed, for example, from a multi-layered light reflecting coating including a multi-layered laminated structure) configured to emit light propagated by total reflection to the interior of the light guide board 121 from the light guide board 121. If an HMD is configured, for example, by such a display device 100′, weight and size reduction of the device may be achieved.

PTL 2, for example, discloses a virtual image display device (display device) using hologram diffraction grating so that a viewer may view a two-dimensional image formed by an image forming device as a virtual image enlarged by a virtual image optical system.

As illustrated in the schematic in FIG. 22, a display device 200′ is basically provisioned with the image forming device 111′ configured to display an image, the collimate optical system 112, and an optical device (light guiding unit) 220 to which light displayed on the image forming device 111′ is illuminated and so configured to guide this light to the pupil 21 of the viewer. Here, the optical device 220 is provisioned with a light guide board 221, and a first diffraction grating 230 and a second diffraction grating 240 configured from a reflecting-type grating provisioned to the light guide board 221. Light emitted from each pixel of the image forming device 111′ is illuminated onto the collimate optical system 112 which then generates multiple beams of parallel light to be illuminated to the light guide board 221 with differing angles, and illuminates this light to the guide board 221. Parallel light is illuminated and then emitted from a first surface 222 of the guide board 221. Conversely, the first diffraction grating 230 and the second diffraction grating 240 are installed to a second surface 223 of the guide board 221 which is parallel to the first surface 222 of the guide board 221.

PTL 3 discloses a high-resolution liquid crystal display device that suppresses screen flickering and is driven by the field sequential method. Here, the field sequential drive method is used to divide an input image signal in one display frame temporally into an image signal of multiple color components (for example, a red color image signal for displaying red color images, a green color image signal for displaying green color images, and a blue color image signal for displaying blue color images), and then the image display is performed in the image forming device. Display of color is performed by sequentially flashing light sources (for example, a red color light emitting source, green color light emitting source, and blue color light emitting source) illuminating the color corresponding to each color component by aligning the display period of each color component, the light sources configured from light-emitting diodes, for example (refer to FIG. 20A). By using the field sequential drive method to display color, the image forming device may be produced with one-third of the pixels as compared, for example, with an image forming device provisioned with color filters for the red color, green color, and blue color, which enables a reduction in size of the display device.

### CITATION LIST

### Patent Literature

### PTL 1: Japanese Unexamined Patent Application Publication No. 2006-162767

### PTL 2: Japanese Unexamined Patent Application Publication No. 2007-094175

### PTL 3: Japanese Unexamined Patent Application Publication No. 2010-055120

### SUMMARY

### Technical Problem

The light sources emitting the color corresponding to each color component (the red color light emitting source, green color light emitting source, and blue color light emitting source) sequentially flash during one display frame in the image forming device utilizing the field sequential drive method to display color, so an image of just one color is displayed if viewed for an extremely short period of time. Thus, a problem of color breakup, that is to say, a different color is recognized from what is normally recognized, occurs when the image is not viewable for some reason (for example, the viewer blinks or the eyeball moves suddenly) during the period in which the image of one of the colors is displayed for one display frame in an HMD provisioned with a left eye image display device and a right eye image display device driven by the field sequential method (refer to FIG. 20B). Particularly, the optical devices in HMDs configuring the display device are arranged in positions extremely close to the pupils of the viewer, which makes this sensitive to the movement of viewer pupils and the like readily causing color breakup.

It has been found desirable to supply a display device provisioned with a left eye image display device and a right eye image display device driven by the field sequential method and a light source for image display devices applicable for use in these display devices in which the phenomenon of color breakup is difficult to recognize.

### Solution to Problem

The display device related to Embodiment 1 or Embodiment 2 according to the present disclosure is provisioned with a frame mounted to the head of a viewer, and a left eye image display device and right eye image display device installed to the frame, wherein each image display device is provisioned with an image forming device configured to display images of multiple colors by the field sequential drive method.

Regarding the display device related to Embodiment 1 according to the present disclosure, the image display color when displaying the left eye image on the left eye image display device and the image display color when displaying the right eye image on the right eye image display are different. Regarding the display device related to Embodiment 2 according to the present disclosure, the image display period when displaying the left eye image on the left eye image display device during one display frame (more specifically, during one image display sub-period described later) and the image display period when displaying the right eye image on the right eye image display device during one display frame (more specifically, during the same image display sub-period) are different.

A light source for an image display device according to the present disclosure is configured including a light source for a left eye image display device provisioned to a left eye image display device, and a light source for a right eye image display device provisioned to a right eye image display device, wherein the light source for the left eye image display device and the light source for the right eye image display device emit light of multiple colors by the field sequential drive method so that images of multiple colors are displayed on the right eye image display device and the left eye image display device, and the period to start light emission regarding the light source for the left eye image display device and the period to start light emission regarding the light source for the right eye image display device are different.

A display device according to at least one embodiment of the present disclosure includes: a first image forming device configured to form a first color image by sequentially displaying a first plurality of single color images according to a first color sequence, wherein the first color sequence defines an order in which each of the first plurality of single color images is displayed, a start time for beginning to display the first plurality of single color images, and a duration over which each of the first plurality of single color images is displayed; and a second image forming device configured to form a second color image by sequentially displaying a second plurality of single color images according to a second color sequence, wherein the second color sequence defines an order in which each of the second plurality of single color images is displayed, a start time for beginning to display the second plurality of single color images, and a duration over which each of the second plurality of single color images is displayed. The first color sequence is different from the second color sequence. At least one light source for a display device according to some embodiments of the present invention includes: a first light source configured to sequentially emit a first plurality of monochromatic light flashes according to a first color sequence, wherein the first color sequence defines an order in which the first plurality of monochromatic light flashes is emitted, a start time for beginning to emit the first plurality of monochromatic light flashes, and a duration over which each of the first plurality of monochromatic light flashes is emitted; and a second light source configured to sequentially emit a second plurality of monochromatic light flashes according to a second color sequence, wherein the second color sequence defines an order in which the second plurality of monochromatic light flashes is emitted, a start time for beginning to emit the second plurality of monochromatic light flashes, and a duration over which each of the second plurality of monochromatic light flashes is emitted. The first color sequence is different from the second color sequence.
A light source control circuit for controlling at least one light source of a display device according to some embodiments of the present disclosure includes: a first pulse generation circuit configured to generate a first pulse sequence for controlling a first light source, wherein the first pulse sequence defines an order in which the first light source emits a first plurality of monochromatic light flashes, a start time for beginning to emit the first plurality of monochromatic light flashes, and a duration over which each of the first plurality of monochromatic light flashes is emitted; and a second pulse generation circuit configured to generate a second pulse sequence for controlling a second light source, wherein the second pulse sequence defines an order in which the second light source emits a second plurality of monochromatic light flashes, a start time for beginning to emit the second plurality of monochromatic light flashes, and a duration over which each of the second plurality of monochromatic light flashes is emitted.
The first pulse sequence is different from the second pulse sequence.

### Advantageous Effects of Invention

Regarding the display device related to Embodiment 1 according to the present disclosure, the image display color when displaying the left eye image on the left eye image display device is different from the image display color when displaying the right eye image on the right eye image display device. Thus, even when the image may not be viewed for some reason during the period in which the image of one color is displayed during one display frame, the image color for the entire frame, or for the entire left eye image display device and the right eye image display device, that is supposed to be recognized is able to be recognized. That is to say, the occurrence of the color breakup phenomenon may be suppressed. Regarding the display device related the Embodiment 2 according to the present disclosure, the image display period when displaying the left eye image on the left eye image display device during one display frame is different from the image display period when displaying the right eye image on the right eye image display device during one display frame. Thus, even when the image may not be viewed for some reason during the period in which the image of one color is displayed during one display frame, the image color for the entire frame, or for the entire left eye image display device and the right eye image display device, that is supposed to be recognized is able to be recognized. That is to say, the occurrence of the color breakup phenomenon may be suppressed. Regarding the light source for the image display device according to the present disclosure, the timing to start light emission from the light source for the left eye image display device and the timing to start the light emission for the right eye image display device are different, so when the image may not be viewed for some reason during the period in which the image of one color is displayed during one display frame, the image color for the entire frame, or for the entire left eye image display device and the right eye image display device, that is supposed to be recognized is able to be recognized. That is to say, the occurrence of the color breakup phenomenon may be suppressed. These effects described in the present specification are only examples and are not limiting in any way, and other effects may also be added.

### BRIEF DESCRIPTION OF DRAWINGS

FIG. 1A is a schematic illustrating an image display state of a left eye image display device and a right eye image display device regarding a display device according to a first exemplary embodiment.

FIG. 1B is a schematic illustrating an image display state of a left eye image display device and a right eye image display device for describing suppression of occurrences of the color breakup phenomenon.

FIG. 2A is a schematic illustrating an image display state of a left eye image display device and a right eye image display device regarding a display device according to a modification of the first exemplary embodiment.

FIG. 2B is a schematic illustrating an image display state of a left eye image display device and a right eye image display device for describing suppression of occurrences of the color breakup phenomenon.

FIG. 3A is a schematic illustrating an image display state of a left eye image display device and a right eye image display device regarding a display device according to a second exemplary embodiment.

FIG. 3B is a schematic illustrating an image display state of a left eye image display device and a right eye image display device for describing suppression of occurrences of the color breakup phenomenon.

FIG. 4A is a schematic illustrating an image display state of a left eye image display device and a right eye image display device regarding a display device according to a modification of the second exemplary embodiment.

FIG. 4B is a schematic illustrating an image display state of a left eye image display device and a right eye image display device for describing suppression of occurrences of the color breakup phenomenon.

FIG. 5 is a schematic of a display device according to the first exemplary embodiment.

FIG. 6 is a schematic of the display device according to the first exemplary embodiment from a top view.

FIG. 7 is a schematic of the display device according to the first exemplary embodiment from a front view.

FIG. 8A is a schematic of the display device according to the first exemplary embodiment from a side view.

FIG. 8B is a diagram schematically illustrating propagation of light on a light guide board configuring an image display device.

FIG. 9 is a schematic of a modification (Modification 1A) of the display device according to the first exemplary embodiment.

FIG. 10 is a schematic of another modification (Modification 1B) of the display device according to the first exemplary embodiment.

FIG. 11 is a schematic of another modification (Modification 1C) of the display device according to the first exemplary embodiment.

FIG. 12 is a cross-sectional diagram schematically illustrating an enlarged portion of a reflecting-type grating regarding another modification (Modification 1C) of the display device according to the first exemplary embodiment illustrated in FIG. 11.

FIG. 13 is a schematic of another modification (Modification 1D) of the display device according to the first exemplary embodiment from a top view.

FIG. 14 is a schematic of another modification (Modification 1D) of the display device according to the first exemplary embodiment from a front view.

FIG. 15A is a schematic of another modification (Modification 1E) of the display device according to the first exemplary embodiment as viewed from the side.

FIG. 15B is a schematic of another modification (Modification 1F) of the display device according to the first exemplary embodiment as viewed from the side.

FIG. 16 is a schematic of an image signal processing circuit.

FIG. 17 is a schematic of a second image signal processing circuit and memory unit configuring an image signal processing circuit.

FIG. 18 is a schematic of a light source control unit configuring an image signal processing circuit.

FIG. 19 is an overall schematic of a display device.

FIG. 20A is a schematic illustrating a display state of a left eye image and a right eye image for describing the color breakup phenomenon.

FIG. 20B is a schematic illustrating a display state of a left eye image and a right eye image for describing the color breakup phenomenon.

FIG. 21 is a schematic of a display device regarding a display device according to the related art.

FIG. 22 is a schematic of a display device regarding a modification of the display device according to the related art.

### DESCRIPTION OF EMBODIMENTS

Hereinafter, the present disclosure will be described on the basis of the embodiments with reference to the drawings, though the present disclosure is not limited to the embodiments, and the various values and materials listed regarding the embodiments are only examples. Further, the description will be organized in the following order:

1. General description of a display device and light source for an image display device related to Embodiment 1 through Embodiment 2 according to the present disclosure;

2. First Exemplary Embodiment (display device related to Embodiment 1 through Embodiment 2A according to the present disclosure, and light source for an image display device related to a first configuration according to the present disclosure); and

3. Second Exemplary Embodiment (display device related to Embodiment 2B according to the present disclosure, and light source for an image display device related to a second configuration according to the present disclosure), and others.

### (General Description of a Display Device and Light Source for an Image Display Device Related to Embodiment 1 Through Embodiment 2 According to the Present Disclosure)

The image display period for one display frame is divided into N number of image display sub-periods in the display device related to Embodiment 2 according to the present disclosure, and so the image display color when displaying a left eye image on a left eye image display device and the image display color when displaying a right eye image on a right eye image display device may have a different form during some nth image display sub-period (where n is a value between 1 and N, including both 1 and N). Further, a display device having such a form will be referred to as a “display device related to Embodiment 2A according to the present disclosure” for brevity. Here, M is designated as the number of multiple colors, in which case M may be equal to N, or N may be greater than M.

Regarding the light source for an image display device according to the present disclosure, the image display period for one display frame is divided into N number of image display sub-periods. Accordingly, the light emission color of a light source of a left eye image display device and the light emission color of a light source of a right eye image display device may differ during some nth image display sub-period (where n is a value between 1 and N, including both 1 and N). Further, a display device having such a form will be referred to as a “light source for an image display device as a first configuration according to the present disclosure” for brevity. Here, M is designated as the number of multiple colors, in which case M may be equal to N, or N may be greater than M.

Regarding the display device related to Embodiment 2 according to the present disclosure, the image display period for one display frame is divided into N number of image display sub-periods. Accordingly, the image display color when displaying a left eye image on a left eye image display device and the image display color when displaying a right eye image on a right eye image display device is the same during some nth image display sub-period (where n is a value between 1 and N, including both 1 and N), but the image display period within some nth image display sub-period may be shifted. Further, a display device having such a form will be referred to as a “display device related to Embodiment 2B according to the present disclosure” for brevity. During one image display sub-period in the display device related to Embodiment 2B according to the present disclosure, the image display period during an image display sub-period when displaying a left eye image on a left eye image display device and the image display period during an image display sub-period when displaying a right eye image on a right eye image display device may not have any temporal overlaps. More specifically, an arrangement may be made wherein, in one image display sub-period, the image display period during an image display sub-period when displaying a left eye image on a left eye image display device and the image display period during an image display sub-period when displaying a right eye image on a right eye image display device may have no temporal overlaps, and in this case, it is preferable that the temporal overlaps are within a range of between 50 to 99% of one image display sub-period. Here, M is designated as the number of multiple colors, in which case M may be equal to N, or N may be greater than M.

Regarding the light source for an image display device according to the present disclosure, the image display period for one display frame is divided into N number of image display sub-periods. Accordingly, the light emission color of a light source of a left eye image display device and the light emission color of a light source of a right eye image display device is the same during some nth image display sub-period (where n is a value between 1 and N, including both 1 and N), but the period in which light begins to emit from the light source for a left eye image display device and the period in which light begins to emit from the light source for a right eye image display device may shifted within some nth image display sub-period. Further, a display device having such a form will be referred to as a “light source for an image display device as a second configuration according to the present disclosure” for brevity. During one image display sub-period in the light source for an image display device according to a second configuration of the present disclosure, the light emitting period of the light source for a left eye image display device and the light emitting period of the light source for a right eye image display device may not have any temporal overlaps. More specifically, an arrangement may be made wherein, in one image display sub-period, the light emitting period of the light source for a left eye image display device and the light emitting period of the light source for a right eye image display device may have no temporal overlaps, and in this case, it is preferable that the temporal overlaps are within a range of between 50 to 99% of one image display sub-period. Here, M is designated as the number of multiple colors, in which case M may be equal to N, or N may be greater than M.

Regarding the display device related to Embodiment 1 through Embodiment 2 according to the present disclosure, and the light source for the image display device according to the present disclosure, examples of three types of colors (M=3) that may be used as the multiple colors include, for example, red, green, and blue. Additionally, one type or multiple types of colors may be added to these three types of colors. For example, a white color light may be added to improve luminance, a complementary color for expanding the color reproduction range, or other colors such as yellow, magenta, and cyan may be added.

Regarding the display device related to Embodiment 1 through Embodiment 2 according to the present disclosure including the preferred forms as described previously, and the light source for the image display device according to the present disclosure including the preferred forms and configurations as previously described, the form may be further provisioned with an image signal processing circuit to receive an image signal from an external source, conduct a predetermined signal processing on the image signal, and convert this to a field sequential drive signal. In this case, the image signal processing circuit may be configured including a first image signal processing circuit configured to perform signal processing on image signals related to multiple colors, a second image signal processing circuit configured to generate field sequential drive signals, a third image signal processing circuit configured to perform signal processing on the field sequential drive signal for one display frame, and a memory unit configured to store one display frame worth of field sequential drive signals. In this case, the second image signal processing circuit may include an image signal determination circuit configured to determine image signals related to the multiple colors, a memory interface between the memory unit, and a memory control circuit configured to control the memory unit. The configuration of the circuits is not limited to these forms. In this case, the memory control circuit may be configured to control the read order of the one frame worth of field sequential drive signals stored in the memory unit so that the image display color when displaying the left eye image on the left eye image display device and the image display color when displaying the right eye image on the right eye image display device are different. Conversely, the memory control circuit may be configured to control the read order of the one frame worth of field sequential drive signals stored in the memory unit so that the image display period when displaying the left eye image on the left eye image display device during one display frame and the image display period when displaying the right eye image on the right eye image display device during one display frame are different. The actual image signal processing circuit may be configured from circuits according to the related art.

Regarding the display device related to Embodiment 1 through Embodiment 2 according to the present disclosure including the preferred forms and configurations described previously, the image forming device may be configured including a light source configured to emit multiple colors of light and a liquid crystal display device configured to control the transmission and reflection of the light emitted from the light source. Conversely, the image forming device may be configured including a light source configured to emit multiple color of light and multiple digital micro-mirror devices configured to control the reflection of the light emitted from the light source. Conversely, the image forming device may also be configured including electrowetting elements, which include a hydrophobic insulating film, a nonpolar liquid, and a polar liquid, configured to control the amount of light to cut off from the nonpolar liquid having non-transparent properties by controlling the contact angle of the polar liquid corresponding to the hydrophobic insulating film by the applied voltage.

Regarding the display device related to Embodiment 1 through Embodiment 2 according to the present disclosure including the preferred forms and configurations described previously, each image display device is further provisioned with an optical device (light guide unit) configured to guide the image from the image forming device to the viewer's pupil. The optical device (light guide unit) may be configured as provisioned with a light guide board configured to emit light after propagating illuminated light to the interior by total reflection, a first deflector configured to deflect the light illuminated by the light guide board so that the light illuminated onto the light guide board is completely reflected to the interior of the light guide board, and a second deflector configured to completely deflect, over multiple times, the light propagated to the interior of the light guide board by total reflection so that the light propagated to the interior of the light guide board by total reflection is emitted from the light guide board. Further, regarding such a configuration, the optical device may be designated as a semitransparent type (see-through type). Specifically, at least a portion of the optical device corresponding to the viewer's pupil (more specifically, the light guide board) is designated as semitransparent (see-through), thus the external view may be viewed through this portion of the optical system. Here, the term “total reflection” indicates the interior total reflection, or the total reflection regarding the interior of the light guide board. This will be the same for the remaining description. Conversely, each image display device may be further provisioned with an optical device (light guide unit) configured to guide the image from the image forming device to the viewer's pupil. The optical device (light guide unit) may be configured as provisioned with a reflecting mirror (this may be semitransparent type or a non-transparent type) configured to reflect the image from the image forming device, and a group of lenses configured to illuminate the image reflected by the reflecting mirror. Further, regarding such a configuration, the optical device may be configured as a semitransparent type (see-through type), or may be configured as a non-transparent type. Conversely, the optical device may be configured to oppose the image forming device configuring the left eye image display device to the viewer's left eye so that the image from the image forming device configuring the left eye image display device reaches the viewer's left eye. The optical device may also be configured to oppose the image forming device configuring the right eye image display device to the viewer's right eye so that the image from the image forming device configuring the right eye image display device reaches the viewer's right eye.

Here, the first deflector may be configured to reflect light illuminated onto the light guide board, and the second deflector may be configured to be transparent and thus completely reflect, over multiple times, light propagated to the interior of the light guide board by total reflection. In this case, the first deflector may be configured to function as a reflecting mirror, and the second deflector may be configured to function as a semitransparent mirror.

In such a configuration, the first deflector may be configured, for example, from metal including alloys, a light reflecting film (one type of mirror) reflecting light illuminated onto the light guide board, and a diffraction grating (a hologram diffraction grating film, for example) to diffract light illuminated onto the light guide board. The second deflector may be configured with a multi-layered laminate structure laminated with multiple layers of dielectric laminate film, a half mirror, a polarizing beam splitter, and a hologram diffraction grating film. The first deflector and the second deflector are arranged in the interior of the light guide board (embedded in the interior of the light guide board), and parallel light illuminated onto the light guide board is reflected or diffracted by the first deflector so that the parallel light illuminated onto the light guide board is completely reflected by the interior of the light guide board. Conversely, the second deflector completely reflects or diffracts, over multiple times, the parallel light propagated to the interior of the light guide board by total reflection is completely reflected or diffracted, and then outputs the parallel light in this state from the light guide board.

Alternatively, the first deflector may be configured to diffract light illuminated onto the light guide board, and the second deflector may be configured to diffract, over multiple times, the light propagated to the interior of the light guide board by total reflection. In this case, the first deflector and the second deflector may be configured as formed from diffraction grating elements. The diffraction grating elements may be configured as formed from a reflecting-type diffraction grating element or a transparent-type diffraction grating element. Alternatively, one of the diffraction grating elements may be configured as formed from a reflecting-type diffraction grating element, and the other diffraction grating element may be configured as formed from a transparent-type diffraction grating element. Further, a reflecting-type volume hologram diffraction grating may also serve as an example of a reflecting-type diffraction grating element. For brevity, the first deflector formed from a reflecting-type volume hologram diffraction grating will be referred to as a “first diffraction grating member”, and the second deflector formed from a reflecting-type volume hologram diffraction grating will be referred to as a “second diffraction grating member”.

As images are displayed in color regarding the image forming device according to the present disclosure, the first diffraction grating member and the second diffraction grating member may be configured having a form in which an M number of diffraction grating layers forming the reflecting type volume hologram diffraction grating are laminated in order to correspond with the reflection and diffraction of an M types of light including different M types of wavelength bands or wavelengths (if M=3, for example, the three types are red, green, and blue). An interference fringe corresponding to one type of wavelength band or wavelength is formed in each diffraction grating layer. Alternatively, a configuration may be designated in which an M type of interference fringes are formed in the first diffraction grating member or the second diffraction grating member formed from one diffraction grating layer in order to correspond with the reflection and diffraction of an M types of light including different M types of wavelength bands (or wavelengths). Alternatively, the field angle may be divided into three portions, and the first diffraction grating member or the second diffraction grating member may be configured as formed by laminating diffraction grating layers corresponding to each field angle. Alternatively, the first diffraction grating member and the second diffraction grating member configured from diffraction grating layers formed from reflecting type volume hologram diffraction gratings that diffract and reflect light including wavelength bands (or wavelengths) in the red color may be arranged in a first light guide board, the first diffraction grating member and the second diffraction grating member configured from diffraction grating layers formed from reflecting type volume hologram diffraction gratings that diffract and reflect light including wavelength bands (or wavelengths) in the green color may be arranged in a second light guide board, and the first diffraction grating member and the second diffraction grating member configured from diffraction grating layers formed from reflecting type volume hologram diffraction gratings that diffract and reflect light including wavelength bands (or wavelengths) in the blue color may be arranged in a third light guide board. A configuration may be adopted in which the first light guide board, the second light guide board, and the third light guide board are laminated with spaces between them. By adopting these configurations, an increase in diffraction efficiency, an increase in diffraction reception angles, and optimization of the diffraction angle may be improved when the light including each wavelength band (or wavelength) is diffracted and reflected in the first diffraction grating member or the second diffraction grating member. It is preferable that a protecting member be arranged so that the reflecting type volume hologram diffraction grating does not make direct contact with air.

A photopolymer material may serve as an example of material for configuring the first diffraction grating member and the second diffraction grating member. The configuration material and the basic configuration of the first diffraction grating member and the second diffraction grating member formed from reflecting type volume hologram diffraction grating may be the same configuration material and basic configuration as the reflecting type volume hologram diffraction grating according to the related art. The reflecting type volume hologram diffraction grating indicates a hologram diffraction grating that diffracts and reflects only +1 order diffraction light. The interference fringe is formed around the surface of the diffraction grating member from the interior, and the method used to form the interference fringe may be the same as the forming method according to the related art. Specifically for example, an object light is irradiated from one side of a first predetermined direction corresponding to the member (for example, a photopolymer material) configuring the diffraction grating member, and at the same time, a reference light is irradiated from a another side of a second predetermined direction corresponding to the member configuring the diffraction grating member, and so the interference fringe formed by the object light and the reference light may be recorded in the interior of the member configuring the diffraction grating member. By appropriately selecting first predetermined direction, the second predetermined direction, and the wavelengths of the object light and the reference light, the desired interference fringe pitch and slant angle along the surface of the diffraction grating member may be obtained. The interference fringe slant angle indicates the angle formed between the surface of the diffraction grating member (or diffraction grating layer) and the interference fringe. When the first diffraction grating member and the second diffraction grating member are configured from a laminate construction of an M number of diffraction grating layers formed from reflecting type volume hologram diffraction grating, an ultraviolet curable adhesive, for example, may be used to laminate (adhere) the M number of diffraction grating layers after individually manufacturing the M number of diffraction grating layers. The M number of diffraction grating layers may be manufactured by manufacturing one diffraction grating layer using a photopolymer material including adhesive properties, and then manufacturing a diffraction grating layer by sequentially applying the photopolymer material including adhesive properties on top of this.

Alternatively, regarding the display device related to Embodiment 1 through Embodiment 2 including the preferred forms and configurations previously described (hereinafter, these may be generally referred to as “the display device according to the present disclosure”), the optical device may be formed of semitransparent mirrors on which light emitted from the image forming device is illuminated, and is then emitted toward the viewer's pupil. Further, the light emitted from the image forming device may be configured to propagate in the air to illuminate onto the semitransparent mirror. For example, this light may be configured to propagate to the interior of a transparent member such as a glass board or plastic board (specifically, a member formed from material similar to material configuring the light guide board described later), and illuminate onto the semitransparent mirror. Further, such a semitransparent mirror may be installed to the image forming device via this transparent member, or the semi-transparent mirror may be installed to the image forming device via a different member than this transparent material.

In the display device according to the present disclosure, the image forming device may be formed including multiple pixels arranged in a two-dimensional matrix. Examples of such an image forming device include a light bulb as an image forming device formed from a reflecting-type spatial light modulator and light source, or as an image forming device formed from a transparent-type spatial light modulator and light source. As a specific example of a reflecting-type spatial light modulator, a combination of a reflecting type of liquid crystal display device such as LCOS (Liquid Crystal On Silicon) and a polarizing beam splitter that reflects and guides a portion of light from a light source to the liquid crystal display device, and transmits and guides a portion of light reflected by the liquid crystal display device to an optical system, a digital micro-mirror device (DMD), and an electro-wetting element. A transparent-type liquid crystal display device may serve as a specific example of a transparent-type spatial light modulator. Examples of light-emitting elements configuring the light source include a red color light-emitting element, a green color light-emitting element, a blue color light-emitting element, a white color light-emitting element, and so on. Examples of the light-emitting element include a semiconductor laser element, fixed laser, or an LED. There may be one or multiple light-emitting elements corresponding to each color. The number of pixels may be determined on the basis of specifications desired for the display device according to the present disclosure. Specific examples of the number of pixels include resolutions such as 320×240, 432×240, 640×480, 1024×768, and 1920×1080.

The optical system (an optical system that emits light as parallel light of which a collimate optical system is a specific example, and may be referred to as a “parallel light-emitting optical system”) of the image display device illuminates multiple beams of parallel light onto the light guide board. The desirability for this kind of light is based on the desire to store the optical wave front information when this light is illuminated onto the light guide board even after the light is emitted from the light guide board via the first deflector and the second deflector. Further, light-emitting units in the image forming device may be positioned, for example, in locations (positions) separated by the focus point distance regarding the parallel light-emitting optical system as a specific example to generate the multiple beams of parallel light. The parallel light-emitting optical system includes a function to convert the positional information of the pixel into angle information regarding the optical system in the optical device. Examples of the parallel light-emitting optical system include individual convex lenses, concave lenses, free-curved prisms, hologram lenses, or combinations thereof, in which the optical system has an overall positive optical power. A shield member including an opening may also be arranged between the parallel light-emitting optical system and the light guide board in order to prevent undesirable light from being cast out from the parallel light-emitting optical system and illuminating onto the light guide board.

The light guide board includes two parallel surfaces (a first surface and a second surface) extending in parallel along the axis of the light guide board (X axis). When the surface of the light guide board to which light illuminates is designated as a light guide board incident surface, and the surface of the light guide board emitting light is designated as a light guide board emitting surface, the light guide board incident surface and the light guide board emitting surface may be configured by the first surface, or the light guide board incident surface may be configured by the first surface, and the light guide board emitting surface may be configured by the second surface. Examples of materials configuring the light guide board include glass including optical glass such as quartz glass and BK7, and plastic materials (for example, styrene resins including PMMA, polycarbonate resin, acrylic resins, noncrystalline polypropylene resins, and AS resins). The form of the light guide board may include a curved form as it is not limited to a flat board.

In the display device according to the present disclosure, a frame may be configured as formed from a front portion arranged to the front of the viewer, and two temple units installed to both ends of the front portion which turn on hinges. Further, drop ends are installed to the end of each temple unit. The image display device is installed to the frame, and as a specific example, the image forming device may be installed to the temple units. The front portion and the two temple units may be configured as a single piece. That is to say, when looking at the entirety of the display device according to the present disclosure, the frame has a construction nearly identical to a typical pair of glasses. The materials configuring the frame including pad portions may be configured from the same materials configuring normal glasses, such as metal, alloys, plastics, and combinations thereof. The configuration may also include nose pads installed to the front portion. That is to say, when looking at the entirety of the display device according to the present disclosure, the assembly of the frame and nose pads has a construction nearly identical to normal glasses except that there is no rim. The nose pads may also have a configuration and construction according to the related art.

From a design perspective and ease of mounting regarding the display device according to the present disclosure, it is preferable if wiring from two image forming devices (signal wiring, power wiring, and so on) is formed to extend from the ends of the drop ends externally via the temple units and the interior of the drop ends, and connect to a control device (control circuit or control unit). Each image forming device is also provisioned with earphone units, and the wiring for the earphone units from each image forming device may be formed to extend from the end of the drop ends to the earphone unit via the interior of the temple units and the drop ends. Examples of the earphone units include inner-ear type earphones and canal type earphones. More specifically, the wiring for the earphone units is preferably formed to extend from the ends of the drop ends to the earphone units wrapping behind the ears (auricles).

An imaging device may be formed as installed in the central portion of the front portion. Specifically, the imaging device is configured including lenses and fixed imaging elements formed from CCD or CMOS sensors, for example. The wiring from the imaging device may connect to one image display device (or image forming device) via the front portion, for example, and may be included in the wiring extending from the image display device (or image forming device).

Light beams emitted from the center of the image forming device passing through an image forming device node of the optical system will be referred to as “central light beams”, and light within the central light beams that illuminated onto the optical device perpendicularly will be referred to as “central incident light beams”. The point where the central incident light beams illuminated onto the optical device is designated as the optical device center point, the axis parallel to the axial direction of the optical device that passes through the optical device center point is designated as the X axis, and the axis matching the normal vector of the optical device that passes through optical device center point is designated as the Y axis. The horizontal direction regarding the display device according to the present disclosure is a direction parallel to the X axis, and hereinafter may be referred to as the “X axis direction”. Here, the optical system is arranged between the image forming device and the optical device so that light emitted from the image forming device becomes parallel light. The light flux made parallel by the optical system is illuminated onto the optical device, guided, and then emitted. The first deflector center point is designated as an “optical device center point”.

The display device according to the present disclosure including the various modifications previously described may be used to display various descriptions, symbols, encodings, indicators, marks, designs, and so on regarding the driving, operation, maintenance, and analysis time of viewable objects (photographic subjects) of various devices, for example. It may be used to display various descriptions, symbols, encodings, indicators, marks, designs, and so on related to viewable objects (photographic subjects) such as people and other objects. It may be used to display moving images and still images. It may be used to display movie subtitles, or descriptions and closed captioning related to synchronized video. It may be used to display various descriptions, content, progression, and descriptions on the background of various viewable objects (photographic subjects) such as plays, Japanese kabuki theater, Japanese theater, Japanese noh comedy, operas, concerts, ballets, various performances, amusement parks, museums, tourist attractions, resorts, tourism information centers, and so on. It may also be used to display closed captioning. Further, the previously described various content corresponds to information corresponding to data related to photographic subjects. Regarding plays, Japanese kabuki theater, Japanese noh theater, Japanese noh comedy, operas, concerts, ballets, various performances, amusement parks, museums, tourist attractions, resorts, tourism information centers, characters as images related to the viewable objects may be displayed in the image display device at the appropriate timing. Specifically for example, image control signals and image signals are sent to the display device according to the present disclosure by the operation of a worker or the control of a computer on the basis of a predetermined schedule or time arrangement in accordance with the progression state of a movie or the progression state of a play or other performance, thus resulting in an image displaying on the image display device according to the present disclosure. Various descriptions related to viewable objects (photographic subjects) such as various devices, people, and other objects are displayed, and the display of various pre-made descriptions related to the viewable objects (photographic subjects) such as various devices, people, and other objects may be performed on the display device according to the present disclosure by capturing images of viewable objects (photographic subjects) such as various devices, people, and other objects with an image capturing device, and analyzing the captured content in the display device according to the present disclosure. Alternatively, the display device according to the present disclosure may be used as a 3D display device. In this case, a detachable polarizing plate or polarizing film is installed as desirable, or a polarizing plate or polarizing film may be bonded to the optical device.

In addition to image signals (for example, character data), luminance data related to the image to be displayed (luminance information), chromaticity data (chromaticity information), or a combination of luminance data and chromaticity data may be included in the image signals sent to the image forming device. The luminance data may correspond to luminance within a predetermined region including the viewable object viewed through the optical device. The chromaticity data may correspond to chromaticity within a predetermined region including the viewable object viewed through the optical device. In this way, the luminance (brightness) of the image displayed may be controlled by including luminance data related to the image, the chromaticity (color) of the image displayed may be controlled by including chromaticity data related to the image, and the luminance (brightness) and the chromaticity (color) of the image displayed may both be controlled by including both luminance data and chromaticity data related to the image. When using luminance data corresponding to luminance within a predetermined region including the viewable object viewed through the image display device, the value of the luminance data may be set so that the luminance value of the image increases (that is to say, so that the image is displayed brighter) as the value of the luminance corresponding to luminance within a predetermined region including the viewable object viewed through the image display device increases. When using chromaticity data corresponding to chromaticity within a predetermined region including the viewable object viewed through the image display device, the value of the chromaticity data may be set so that the chromaticity value of the image to be displayed and the value of the chromaticity corresponding to chromaticity within a predetermined region including the viewable object viewed through the image display device has an approximate complementary color relationship. The complementary color is specified by the combined color relationship indicated by the opposite position on a color circle. The complementary color of red is green, the complementary color of yellow is purple, the complementary color blue is orange, and so on. This also applies to mixing the appropriate amount of a different color to some color regarding colors that reduce the chroma such as when the color of light is white and the color of the object is black, but the level of compliment is different as the case when the level of visual effect compliment is mixed when parallel. These are also called contrasting or opposite colors. However, opposite colors have a slightly larger range to specify the complementary color than that directly specifying the reciprocal color to the complementary color. The combination of complementary colors has a synergistic effect to bring out the other color, and this is called the complementary color harmony.

### First Exemplary Embodiment

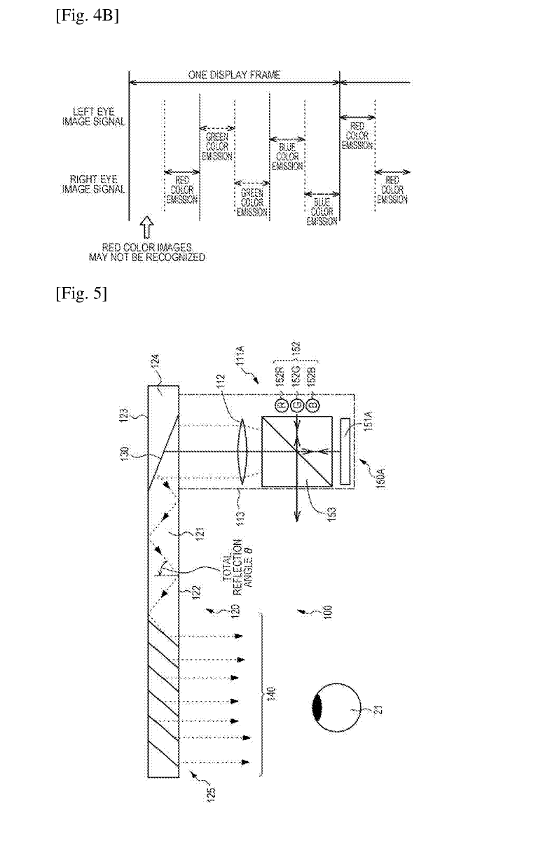

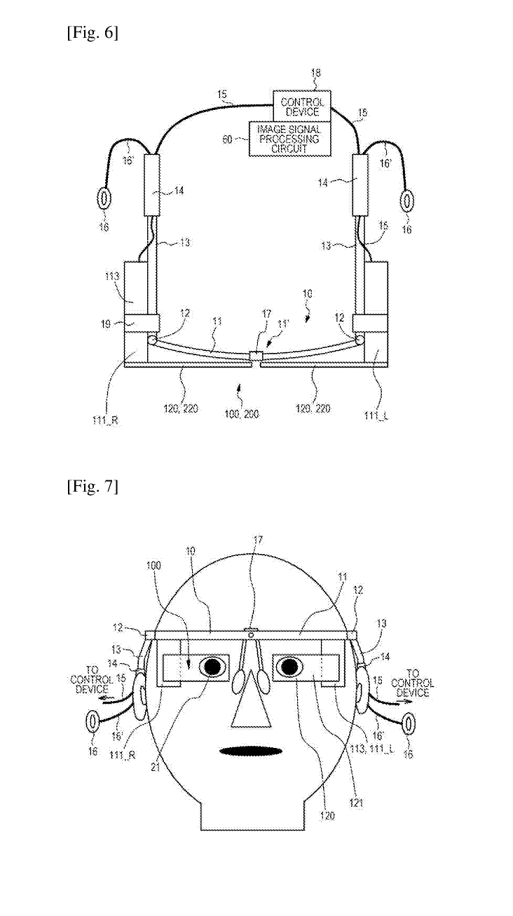

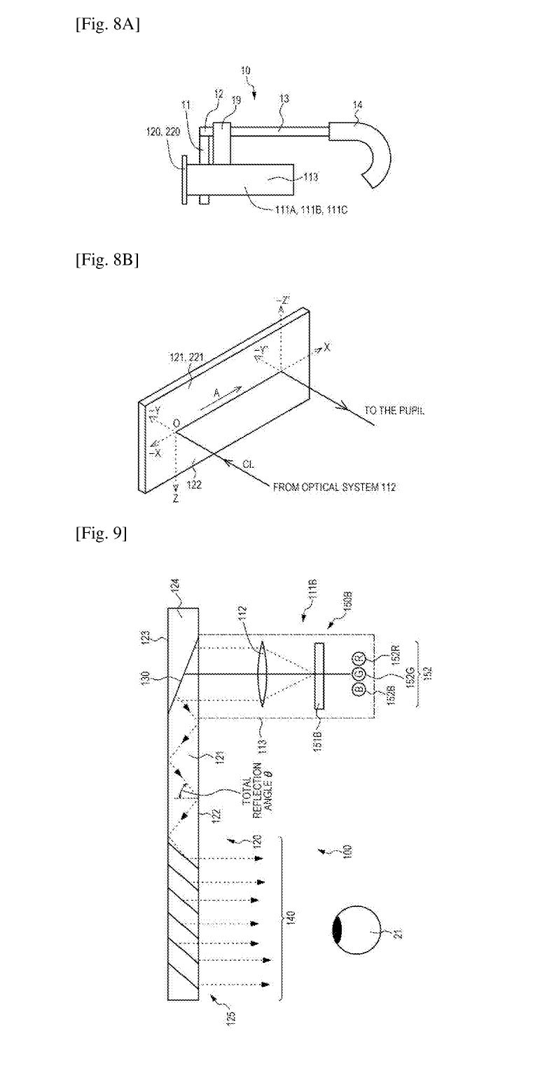

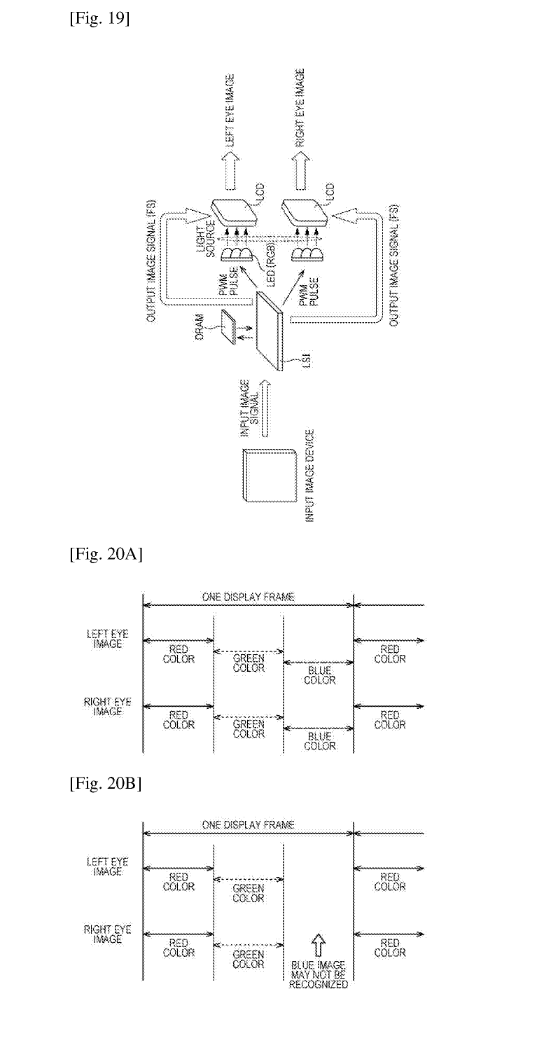

The first exemplary embodiment is related to the display device related to Embodiment 1 according to the present disclosure, the display device related to Embodiment 2A according to the present disclosure, and the light source for an image display device according to the present disclosure, and specifically relates to a first configuration of the light source for an image display device according to the present disclosure. A schematic of the image display device according to the first exemplary embodiment is illustrated in FIG. 5, a schematic of the display device according to the present Embodiment when viewed vertically is illustrated in FIG. 6, a schematic when viewed from the front is illustrated in FIG. 7, and a schematic when viewed from the side is illustrated in FIG. 8A. The propagation of light in the light guide board configuring the image display device is schematically illustrated in FIG. 8B. A schematic of the entire display device is illustrated in FIG. 19, but according to this example, the image signal processing circuit is configured from an LSI, the memory unit is configured from DRAM, the image forming device is configured from a liquid crystal display device (LCD), and the light source is configured from a light-emitting diode (LED). Further, the memory unit may also be mounted in the LSI.

The display device according to the first exemplary embodiment or the second exemplary embodiment described later is specifically a head-mounted display (HMD), and is provisioned with a frame mounted to the head of the viewer (for example, a spectacle type frame 10), and a left eye image display device and a right eye image display device installed to the frame 10 (these devices are represented as image display devices 100, 200, 300, 400, and 500). Each image display device 100, 200, 300, 400, and 500 are provisioned with an image forming device 111A, 111B, and 111C configured to display images of multiple colors by the field sequential drive method. Further, the image forming device configuring the left eye image display device in the drawings is represented with the reference numeral 111_L, and the image forming device configuring the right eye image display device is represented with the reference numeral 111_R.

The light source for an image display device according to the first exemplary embodiment is configured including a light source for a left eye image display device provisioned to a left eye image display device, and a light source for a right eye image display device provisioned to a right eye image display device. The light source for a left eye image display device and the light source for a right eye image display device emit light of multiple colors by the field sequential drive method in order to display images of multiple colors in the left eye image display device and the right eye image display device.

Here, each image display device 100, 200, and 300 are further provisioned with optical devices (light guide unit) 120, 220, and 320 configured to guide and emit illuminated light which was emitted from each image forming device 111A, 111B, and 111C. These devices are also provisioned with an optical system (parallel light-emitting optical system) 112 configured to make the light emitted from the image forming devices 111A, 111B, and 111C into parallel light. Light flux made into parallel light by the optical system 112 is illuminated onto, guided, and emitted from the optical device 120, 220, and 320.

The image display device 100, 200, and 300 may be installed permanently to the frame 10, or may be installed to be detachable. Here, the optical system 112 is arranged between the image forming devices 111A, 111B, and 111C and the optical devices 120, 220, and 320. The light flux made into parallel light by the optical system 112 is illuminated onto, guided, and emitted from the optical devices 120, 220, and 320. The optical devices 120, 220, and 320 are semitransparent (see-through types). Specifically, at least the portions of the optical device corresponding to both eyes of the viewer (more specifically, at least light guide boards 121 and 221 described later and second deflectors 140 and 240) are semitransparent (see-through).

In the first exemplary embodiment or the second exemplary embodiment described later, light is emitted from the center of the image forming devices 111A, 111B, and 111C, and the point where the central incident light beams from among the light beams (central light beams CL) passing through the image forming device node of the optical system 112 are perpendicularly illuminated onto the optical devices 120 and 220 is designated as the optical device central point 0. The axis parallel to the axial direction of the optical devices 120 and 220 is designated as the X axis, and the axis matching the normal vector of the optical devices 120 and 220 passing through the optical device central point 0 is designated as the Y axis. Further, the central point of the first deflectors 130 and 230 described next are also designated as the optical device central point 0. That is to say, as illustrated in FIG. 8B, light is emitted from the center of the image forming devices 111A, 111B, and 111C in the image display devices 100 and 200, and the central incident light beams CL passing through the image forming device node of the optical system 112 collide perpendicularly with the light guide boards 121 and 221. That is to say, the central incident light beams CL are illuminated to the light guide boards 121 and 221 at an incident angle of zero degrees. In this case, the center of the displayed image matches the perpendicular direction of first surfaces 122 and 222 of the light guide boards 121 and 221.

The optical devices 120 and 220 according to the first exemplary embodiment and the second exemplary embodiment described later are provisioned with the light guide boards 121 and 221 to which illuminated light is internally propagated by total reflection, the first deflectors 130 and 230 configured to deflect light illuminated onto the light guide boards 121 and 221 so that the light illuminated onto the light guide boards 121 and 221 are completely reflected to the interior of the light guide boards 121 and 221, and second deflectors 140 and 240 configured to deflect, over multiple times, the light propagated to the interior of the light guide boards 121 and 221 by total reflection in order to emit the light propagated to the interior of the light guide boards 121 and 221 by total reflection from the light guide boards 121 and 221.

In the example illustrated in FIG. 5, the first deflector 130 and second deflector 140 are arranged to the interior of the light guide board 121. The first deflector 130 reflects light illuminated onto the light guide board 121, and the second deflector 140 transmits and reflects, over multiple times, the light propagated to the interior of the light guide board 121 by total reflection. That is to say, the first deflector 130 functions as a reflecting mirror, and the second deflector 140 functions as a semitransparent mirror. More specifically, the first deflector 130 installed to the interior of the light guide board 121 is made from aluminum (Al), and is configured from a light reflecting film (type of mirror) to reflect light illuminated onto the light guide board 121. Conversely, the second deflector 140 installed to the interior of the light guide board 121 is configured from a multi-layered laminate structure laminated with multiple layers of a dielectric laminate film. The dielectric laminate film is formed from a TiO₂ film as a high dielectric constant material and an SiO₂ film as a low dielectric constant material. Japanese Unexamined Patent Application Publication (Translation of PCT Application) No. 2005-521099 discloses a multi-layered laminate structure laminated with multiple layers of a dielectric laminate film. Six layers of the dielectric laminate film are illustrated in the diagram, but the present disclosure is not limited thusly. A flake formed from the same material as the material configuring the light guide board 121 is sandwiched between the dielectric laminate film and another dielectric laminate film. Further, the parallel light illuminated onto the light guide board 121 is reflected (or deflected) so that the parallel light illuminated onto the light guide board 121 in the first deflector 130 is completely reflected to the interior of the light guide board 121. Conversely, the parallel light propagated by total reflection to the interior of the light guide board 121 regarding the second deflector 140 is reflected (or deflected), over multiple times, to be emitted toward the pupil 21 of the viewer from the light guide board 121 in the state in which the light is parallel.

The first deflector 130 may be provisioned to the light guide board 121 as a slanted surface by cutting the light guide board 121 into a portion 124 for provisioning the first deflector 130, vacuum depositing a light-reflecting film to the slanted surface, and then attaching the cut portion 124 of the light guide board 121 to the first deflector 130. The second deflector 140 may be manufactured by a multi-layered structure being formed of multiple layers of the dielectric material film (for example, this may be laminated by vacuum deposition) and the same material as the material configuring the light guide board 121 (for example, glass), forming a slanted surface by cutting a portion 125 of the light guide board 121 for provisioning the second deflector 140, attaching the multi-layered structure to the slanted surface, and polishing to prepare the outer shape. In this way, the optical device 120 provisioned with the first deflector 130 and the second deflector 140 to the interior of the light guide board 121 may be obtained.

Regarding the first exemplary embodiment and the second exemplary embodiment described later, the light guide boards 121 and 221 formed from optical glass or plastic material includes two parallel surfaces (first surfaces 122 and 222, and second surfaces 123 and 223) that extend parallel to the light propagation direction (X axis) completely reflected to the interior of the light guide boards 121 and 221. The first surfaces 122 and 222 face the second surfaces 123 and 223. Parallel light is illuminated from the first surfaces 122 and 222 corresponding to the light incident surface, which is then emitted from the first surfaces 122 and 222 corresponding to the light emitting surface after propagation to the interior by total reflection. However, the present disclosure is not limited thusly, the light incident surface may be configured by the second surfaces 123 and 223, and the light emitting surface may be configured by the first surfaces 122 and 222.

In the example illustrated in FIG. 5, the image forming device 111A includes multiple pixels arranged in a two-dimensional matrix. Specifically, the image forming device 111A is configured including a reflecting-type spatial light modulation device 150A, and a light source 152 including a red color light-emitting diode 152R for emitting red light, a green color light emitting diode 152G for emitting green light, and a blue color light-emitting diode 152B for emitting blue light. That is to say, according to the first exemplary embodiment, the multiple colors include the three colors red, green, and blue (M=3). The entirety of each image forming device 111A is contained in a chassis 113 (illustrated as a dotted line in FIG. 5), an opening is provisioned to the chassis 113 (not illustrated), and light is emitted from the optical system 112 (parallel light-emitting optical system or collimate optical system) via the opening. The reflecting-type spatial light modulation device 150A is configured including a liquid crystal display device (LCD) 151A formed from LCOS as a light bulb, and a polarizing beam splitter 153 that reflects a portion of light from a light source 152 and guides this to the liquid crystal display device 151A, and transmits a portion of the light reflected by the liquid crystal display device 151A and guides this to the optical system 112. The liquid crystal display device 151A is provisioned with multiple pixels (liquid crystal cells) arranged in a two-dimensional matrix (for example, 640×480 pixels). The polarizing beam splitter 153 has a configuration and construction according to the related art. The light emitted from the light source 152 that is not polarized collides with the polarizing beam splitter 153. P-polarized light components pass through the polarizing beam splitter 153 and are emitted outside of the system. Conversely, S-polarized light components are reflected by the polarizing beam splitter 153, illuminated onto the liquid crystal display device 151A, reflected to the interior of the liquid crystal display device 151A, and emitted from the liquid crystal display device 151A. Light is emitted from the liquid crystal display device 151A, and the P-polarized light components from among the light that collides with the polarizing beam splitter 153 passes through the polarizing beam splitter 153 and guided toward the optical system 112. Conversely, the S-polarizing light components are reflected by the polarizing beam splitter 153 and return to the light source 152. The optical system 112 is configured including a convex lens, for example, and the image forming device 111 (more specifically, the liquid crystal display device 151A) is arranged at locations (positions) regarding the focal length of the optical system 112 in order to generate parallel light.

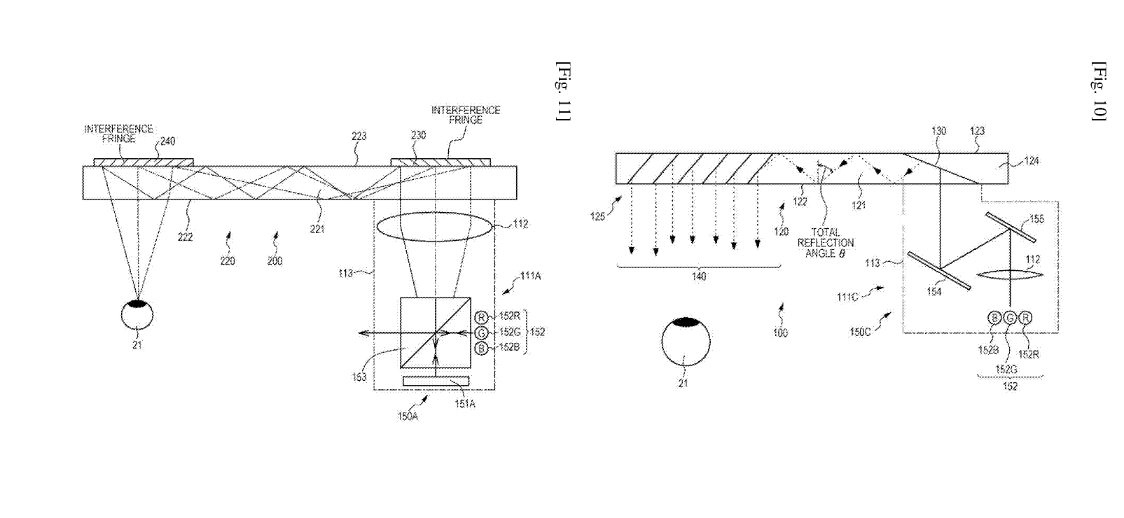

Alternatively, as illustrated in FIG. 9 by the schematic of a modification (Modification 1A) of the display device according to the first exemplary embodiment, the image forming device 111B is configured including a transparent-type spatial light modulation 150B (specifically, the liquid crystal display device 151B as a light bulb), the red color light emitting diode 152R for emitting red color light, and the light source 152 made from the green color light emitting diode 152G for emitting green color light, and the blue color light emitting diode 152B for emitting blue color light. The light emitted from the light source 152 that is not polarized passes through a first polarizing plate, which is not illustrated, is illuminated onto the liquid crystal display device 151B, passes through to the interior of the liquid crystal display device 151B, emitted from the liquid crystal display device 151B, and passes through a second polarizing plate, which is not illustrated, toward the optical system 112.

Alternatively, as illustrated in FIG. 10 by the schematic of a modification (Modification 1B) of the display device according to the first exemplary embodiment, the image forming device 111C may be configured including the light source 152 made from the red color light emitting diode 152R for emitting red color light, the green color light emitting diode 152G for emitting green color light, the blue color light emitting diode 152B for emitting blue color light, and multiple digital micro-mirror devices 154 configured to control the reflection of light emitted from the light source 152. The light emitted from the light source 152 passes through the optical system 112, is reflected at the reflecting mirror 155, and input to the digital micro-mirror device 154. The light is then reflected at the digital micro-mirror device 154, and the light emitted from the digital micro-mirror device 154 then heads toward the optical device 120.

Alternatively, as illustrated in FIG. 11 by the schematic of a modification (Modification 1C) of the display device according to the first exemplary embodiment, the first deflector and the second deflector may be arranged to the front surface of the light guide board 221 (specifically, the second surface 223 of the light guide board 221). The first deflector diffracts light illuminated onto the light guide board 221, and the second deflector diffracts, over multiple times, light propagated to the interior of the light guide board 221 by total reflection. Here, the first deflector and the second deflector are made from a diffraction grating element, specifically a reflecting type diffraction grating element, and more specifically a reflecting type volume hologram diffraction grating. Regarding the description hereinafter, for brevity, the first deflector made from a reflecting type volume hologram diffraction grating will be referred to as a “first diffraction grating member 230”, and the second deflector made from a reflecting type volume hologram diffraction grating will be referred to as a “second diffraction grating member 240”.

The example illustrated in FIG. 11 uses the image forming device 111A provisioned with the reflecting type spatial light modulation 150A (the liquid crystal display device 151A), the light source 152, and the polarizing beam splitter 153, but alternatively, the image forming device 111B configured including the transparent-type spatial light modulation 150B (liquid crystal display device 151B) and the light source 152 may also be used. The image forming device 111C configured from the light source 152 regarding the Modification 1B illustrated in FIG. 10, and the digital micro-mirror device 154 may also be used.

The first diffraction grating member 230 and the second diffraction grating member 240 are configured by laminating three layers of diffraction grating. An interference fringe corresponding to the type of wavelength band (or wavelength) is formed in each diffraction grating layer, which if formed from photopolymer material, and this is manufactured using methods according to the related art. The pitch of the interference fringe formed in each diffraction grating layer (diffracting optical element) is fixed, the interference fringe has a straight line form, and parallel to the Z axis. The axial lines of the first diffraction grating member 230 and the second diffraction grating member 240 are parallel to the X axis, and the natural vectors are parallel to the Y axis.

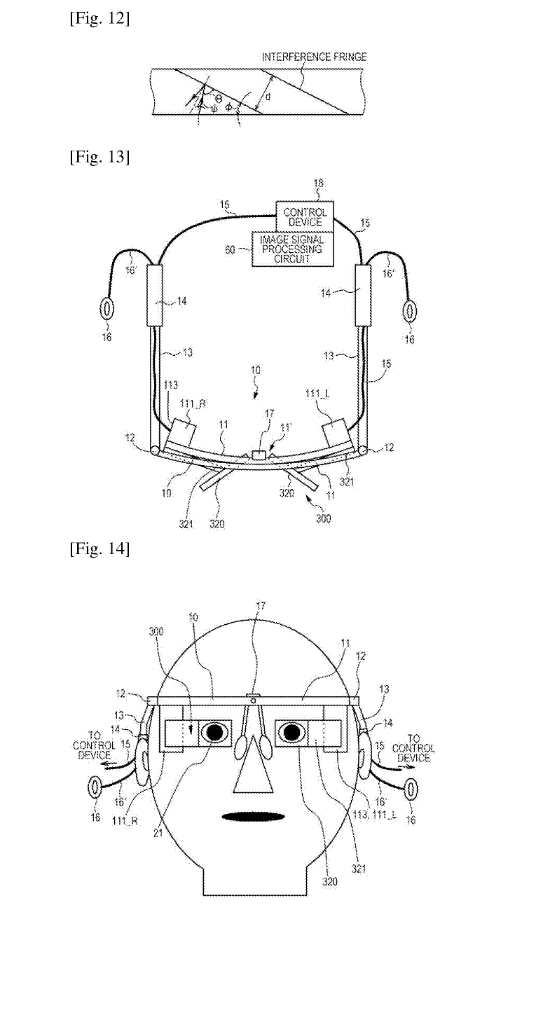

FIG. 12 schematically illustrates an expanded portional cross section of the reflecting type volume hologram diffraction grating. An interference fringe having a slant angle phi is formed in the reflecting type volume hologram diffraction grating. Here, the slant angle phi indicates the angle formed between the front surface of the reflecting type volume hologram diffraction grating and the interference fringe. The interference fringe if formed around the front surface from the interior of the reflecting type volume hologram diffraction grating. The interference fringe satisfies the Bragg condition. Here, the Bragg condition indicates the condition satisfying the following Expression A. In Expression A, m is a positive integer, lambda is the wavelength, d is the pitch of the grating surface (interval in the natural vector direction on a virtual plane including the interference fringe), and theta is the complementary angle to the angle at which light is illuminated onto the interference fringe. An incident angle psi is used in Expression B to establish the relationship between theta, the slant angle phi, and the incident angle psi when light passes through the diffraction grating member.

m*lambda=2*d*sin(theta) (A)

theta=90 degrees−(phi+psi) (B)

As previously described, the first diffraction grating member 230 is arranged (attached to) the second surface 223 of the light guide board 221, and the parallel light illuminated onto the light guide board 221 is diffracted/reflected so that this parallel light illuminated onto the light guide board 221 from the first surface 222 is completely reflected to the interior of the light guide board 221. As previously described, the second diffraction grating member 240 is arranged (attached to) the second surface 223 of the light guide board 221, and the parallel light propagated to the interior of the light guide board 221 by total reflection is diffracted/reflected, over multiple times, from the light guide board 221 to be emitted as it is from the first surface 222.

The parallel light is then emitted from the light guide board 221 after being propagated to the interior by total reflection. At this time, the light path proceeding toward the thin interior of the light guide board 221 is long, and so the number of total reflections until the second diffraction grating member 240 is different for each image. More specifically, the number of reflections of parallel light illuminated at an angle in a direction near the second diffraction grating member 240 from among the parallel light illuminated onto the light guide board 221 is smaller than the number of reflections of parallel light illuminated onto the light guide board 221 at an angle in a direction away from the second diffraction grating member 240. This is because the angle formed between the natural vector of the light guide board 221 when light propagated to the interior of the light guide board 221 collides with the interior surface of the light guide board 221 and the parallel light illuminated onto the light guide board 221 at an angle in a direction near the second diffraction grating member 240, which is the parallel light diffracted/reflected by the first diffraction grating member 230, is smaller than the angle formed with the parallel light illuminated onto the light guide board 221 at an angle in a direction opposite to the aforementioned direction. The form of the interference fringe formed in the interior of the second diffraction grating member 240 and the form of the interference fringe formed in the interior of the first diffraction grating member 230 has an asymmetric relationship regarding a virtual plane perpendicular to the axial line of the light guide board 221.

Alternatively, as illustrated in FIG. 13 by the schematic of the display device when viewed from the top, and in FIG. 14 by the schematic when viewed from the front, regarding another modification (Modification 1D) of the display device according to the first exemplary embodiment, the optical device 320 configuring the image display device 300 is configured from a semitransparent mirror onto which the light emitted from the image forming devices 111A, 111B, and 111C are illuminated, and then emitted toward the pupil 21 of the viewer. The light emitted from the image forming devices 111A, 111B, and 111C is constructed to propagate to the interior of a transparent member 321 such as a glass plate or plastic plate, and illuminate onto the optical device 320 (semi-transparent mirror), but it may be constructed to propagate in the air and illuminate onto the optical device 320. The image forming devices 111A, 111B, and 111C are installed to a front portion 11 by screws. A member 321 is installed to the image forming devices 111A, 111B, and 111C, and the optical device 320 (semi-transparent mirror) is installed to the member 321.

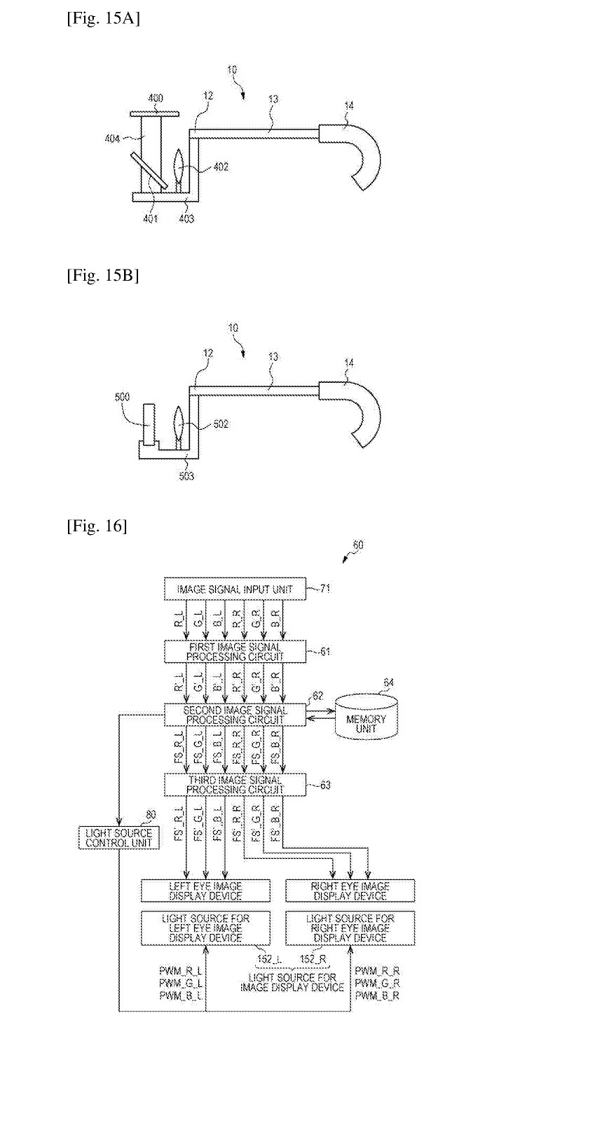

Alternatively, as illustrated in FIG. 15A by the schematic of another modification (Modification 1E) of the display device according to the first exemplary embodiment when looking from the side, the image display device 400 is arranged higher than the pupil of the viewer. The image display device 400 is further provisioned with an optical device (light guide unit) to guide images from the image forming devices 111A, 111B, and 111C to the pupil 21 of the viewer. The optical device (light guide unit) is provisioned with a reflecting mirror 401 (may be semi-transparent or may be non-transparent) configured to reflect images from the image forming devices, and a lens group 402 configured to illuminate images reflected by the reflecting mirror 401. The reflecting mirror 401 and the lens group 402 are installed to an installation member 403, which is installed to the frame 10, and the image display device 400 is installed to an installation member 404 extending from the installation member 403.

Alternatively, as illustrated in FIG. 15B by the schematic of another modification (Modification 1F) of the display device according to the first exemplary embodiment, an image forming device configuring a left eye image display device 500 may be configured to face the left eye of the viewer so that images from the image forming device configuring the left eye image display device reaches the left eye of the viewer, and an image forming device configuring a right eye image display device may be configured to face the right eye of the viewer so that images from the image forming device configuring the right eye image display device reaches the right eye of the viewer. The left eye image display device, the right eye image display device, and a lens group 502 are installed to an installation member 503, which is installed to the frame 10.

The frame 10 is formed from the front portion 11 arranged to the front of the viewer, two temple units 13 installed to be turnable via a hinge 12 on both ends of the front portion 11, and a drop end (also referred to as tip cell, ear cover, or ear pad) 14 installed to the end of each temple unit 13. Nose pads (not illustrated) are also installed. That is to say, the assembly of the frame 10 and the nose pads has basically the same construction as a normal pair of spectacles. Each chassis 113 is installed to be detachable to the temple unit 13 by an installation member 19. The frame 10 is manufactured from metal or plastic. Each chassis 13 may be installed to be not detachable to the temple unit 13 by the installation member 19. For viewers who wear spectacles, each chassis 113 may be installed to be detachable to the temple units of the frame of the viewer's spectacles by the installation member 19. Each chassis 113 may be installed to the exterior of the temple unit 13, or each chassis 113 may be installed to the interior of the temple unit 13.

A wiring (signal wiring and power wiring) 15 extending from the image forming devices 111_R and 111_L extend to the exterior from the ends of the drop end 14 via the interior of the temple unit 13 and the drop end 14, and connect to a control device (control circuit, control unit) 18. The image forming devices 111_R and 111_L are provisioned with an earphone unit 16, and an earphone unit wiring 16′ extending from the image forming devices 111_R and 111_L extend to the earphone unit 16 from the end of the drop end 14 via the temple unit 13 and the interior of the drop end 14. More specifically, the earphone unit wiring 16′ extends from the end of the drop end 14 to the earphone unit 16 wrapping behind the ear (auricle). Such a configuration enables a comfortable display device without giving an impression that the earphone unit 16 and earphone unit wiring 16′ were arranged haphazardly.

The wiring (signal wiring and power wiring) 15 is connected to the control device (control circuit or control unit) 18. An image signal processing circuit 60 is provisioned to the control device 18. Image display processing is performed by the control device 18. The control device 18 and the image signal processing circuit 60 may be configured from circuits according to the related art.

An image capturing device 17 configured including a lens (not illustrated) and a fixed image capturing element made from a CCD or CMOS sensor is installed to a central portion 11′ of the front portion 11 by an appropriate installation member (not illustrated). The signal from the image capturing device 17 is sent to the image forming device 111_R, for example, via wiring (not illustrated) extending from the image capturing device 17.

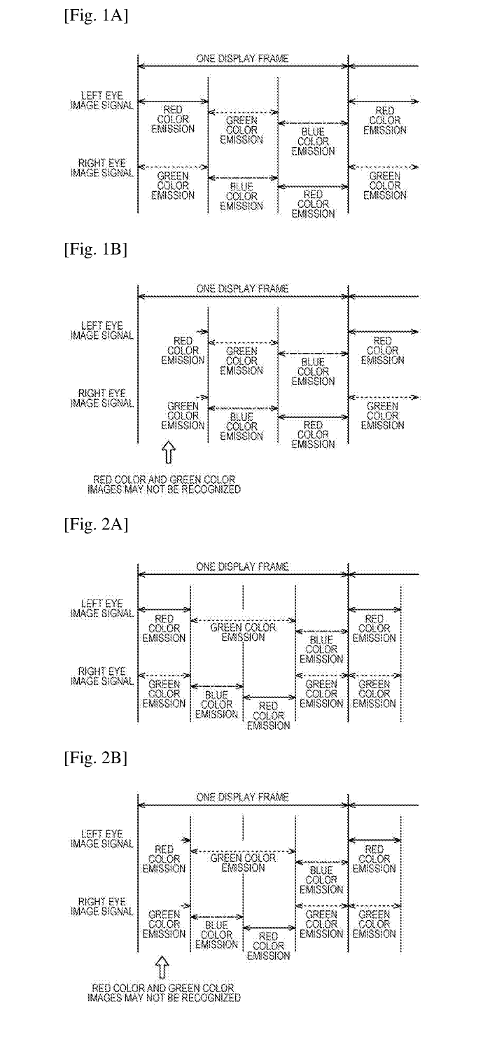

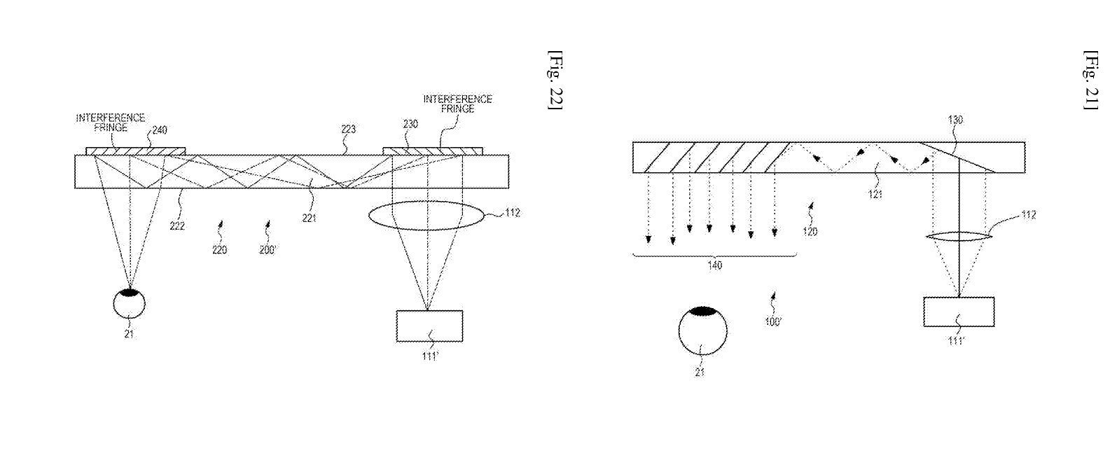

Regarding the display device according to the first exemplary embodiment, as illustrated in FIG. 1A by the schematic illustrated the image display state of the left eye image display device and the right eye image display device regarding the display device according to the first exemplary embodiment, the image display color when displaying the left eye image on the left eye image display device and the image display color when displaying the right eye image on the right image display device are different. The timing to start light emission regarding the light source for the left eye image display device and the timing to start light emission regarding the light source for the right eye image display device is also different in the light source for the image display device according to the first exemplary embodiment. A delay in signal processing in the interior of the display device is ignored when images are displayed in the display devices illustrated in FIG. 1A, the aforementioned FIGS. 20A and 20B, and FIGS. 1B, 2A, 2B, 3A, 3B, 4A, and 4B described later.

Alternatively, when describing the display device according to Embodiment 2A of the present disclosure, the image display period during one display period is divided into an N number of image display sub-periods. Regarding an nth image display sub-period (where n is a value between 1 and N, including both 1 and N), the image display color when displaying the left eye image on the left eye image display device and the image display color when displaying the right eye image on the right eye image display device are different. When describing the first configuration of the light source for the image display device according to the present disclosure, the image display period during one display period is divided into an N number of image display sub-periods. Regarding an nth image display sub-period (where n is a value between 1 and N, including both 1 and N), the emitted color when displaying the left eye image on the left eye image display device and the emitted color when displaying the right eye image on the right eye image display device are different.

Specifically, as illustrated in FIG. 1A, when the left eye image signal for displaying a red color image is input into the left eye image display device, the right eye signal for displaying a green color image is input into the right eye image display device. When the left eye image signal for displaying a green color image is input into the left eye image display device, the right eye image signal for displaying a blue color image is input into the right eye image display device. When the left eye image signal for displaying a blue color image is input into the left eye image display device, the right eye image signal for displaying a red color image is input into the right eye image display device.

Regarding the display device according to the first exemplary embodiment or the second exemplary embodiment described later, or the light source for the image display device, the image signal processing circuit 60 is further provisioned to receive an image signal (input image signal) externally, perform a predetermined signal processing on the image signal (input image signal), and convert the signal into a field sequential drive signal. As illustrated in FIG. 16, the image signal processing circuit 60 here is configured including a first image signal processing circuit 61 configured to perform signal processing on image signals for multiple colors (specifically and mainly, red color image signals R_L and R_R for displaying a red color image, green color image signal G_L and G_R for displaying a green color image, and blue color image signals B_L and B_R for displaying blue color images), a second image signal processing circuit 62 configured to generate field sequential drive signals (field sequential drive signals FS_R_L and FS_R_R for displaying red color images, field sequential drive signals FS_G_L and FS_G_R for displaying green color images, and field sequential drive signals FS_B_L and FS_B_R for displaying blue color images), a third image signal processing circuit 63 configured to perform signal processing during one display frame on the field sequential drive signals, and a memory unit 64 configured to store one display frame worth of field sequential drive signals. The image signal processing circuit 60 is also provisioned with an image signal input unit 71 configured to receive image signals externally, and a light source control unit 80 configured to control the light emission timing and light emission period for the light source 152. Further, “_L” in the reference numerals representing the signals indicates a left eye signal, and “_R” indicates a right eye signal.

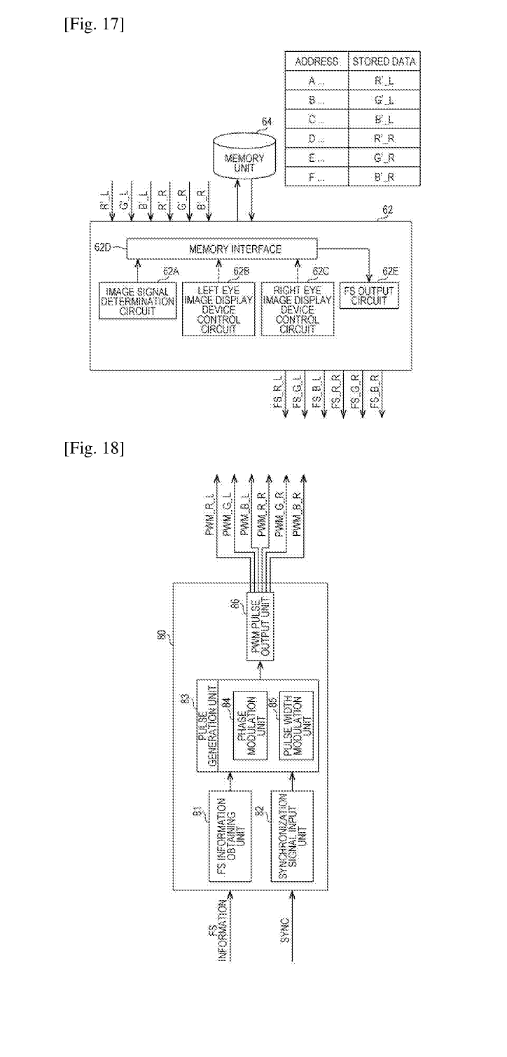

As illustrated in FIG. 17, the second image signal processing circuit 62 includes an image signal determination circuit 62A configured to determine image signals for multiple colors, a memory interface 62D between the memory unit 64, a memory control circuit (specifically, a left eye image display device control circuit 62B and a right eye image display device control circuit 62C) configured to control the memory unit 64, and an FS output circuit 62E. RGB conversion is performed on the input image signal by the image signal determination circuit 62A, for example, when using the YUV format. There may be cases when the image signal determination circuit 62A is not desirable. The memory control circuits 62B and 62C control the read order of the one display frame worth of field sequential drive signals stored in the memory unit 64 so that the image display color when displaying the left eye image on the left eye image display device and the image display color when displaying the right eye image on the right eye image display device are different.

First, the first image signal processing circuit 61 performs signal processing for each color such as gamma correction and color correction on the red color image signals R_L and R_R for displaying a red color image, green color image signal G_L and G_R for displaying a green color image, and blue color image signals B_L and B_R for displaying blue color images from the image signal input unit, and these signals are output from the first image signal processing circuit 61 as image signals R′_L, R′_R, G′_L, G′_R, B′_L, and B′_R. These signals are input into the second image signal processing circuit 62 and converted into field sequential drive signals FS_R_L, FS_R_R, FS_G_L, FS_G_R, FS_B_L, and FS_B_R.

Specifically, the one display frame worth of image signals R′_L, R′_R, G′_L, G′_R, B′_L, and B′_R are stored in the memory unit 64 at a state in which the red color, green color, and blue color can be determined (that is to say, at a state in which the red color image signal, the green color image signal, and the blue color image signal are readable when reading image signals). The red color image signal, the green color image signal, and the blue color image signal are then independently read from under control by the memory control circuits 62B and 62C in a predetermined sequence (refer to FIG. 1A) at a speed three times that of the input speed in order to time-division output the red color image signal, the green color image signal, and the blue color image signal stored in the memory unit 64. The image signals read from the memory unit 64 are converted into the field sequential drive signals FS_R_L, FS_R_R, FS_G_L, FS_G_R, FS_B_L, and FS_B_R by the FS output unit 62E, and then output to the third image signal processing circuit 63.

Signal processing is conducted in the third image signal processing circuit 63 mainly to compare the red color image signal, the green color image signal, and the blue color image signal between one display frame and the next display frame, and then these signals are output to the left eye image display device and the right eye image display device as the field sequential drive signals FS′_R_L, FS′_R_R, FS′_G_L, FS′_G_R, FS′_B_L, and FS′_B_R. Images are then displayed on the image forming devices 111A, 111B, and 111C on the basis of the field sequential drive.

Control pulses representing the light emission timing and light emission period for the light sources 152R, 152G, and 152B are generated by the light source control unit 80 and output to the light sources 152R, 152G, and 152B. The light sources 152R, 152G, and 152B flash on the basis of the control pulses.

As illustrated in FIG. 18 specifically regarding the light source control unit 80, information related to the field sequential drive from the second image signal processing circuit 62 (FS information, for example, a sequence of a red color image signal, green color image signal, and blue color image signal regarding the left eye image signal, and a sequence of a red color image signal, green color image signal, and blue color image signal regarding the right eye image signal) is obtained by an FS information obtaining unit 81. Conversely, a synchronization signal input unit 82 receives a synchronization signal SYNC after the image signals are read. Then, control pulses PWM_R_L, PWM_G_L, PWM_B_L, PWM_R_R, PWM_G_R, and PWM_B_R are generated by a pulse generating unit 83 on the basis of the output from the FS information obtaining unit 81 and the synchronization signal input unit 82. The control pulse PWM_R_L corresponds to the red color image signal written to the image forming devices 111A, 111B, and 111C for the left eye image display device. The control pulse PWM_G_L corresponds to the green color image signal written to the image forming devices 111A, 111B, and 111C for the left eye image display device. The control pulse PWM_B_L corresponds to the blue color image signal written to the image forming devices 111A, 111B, and 111C for the left eye image display device. Conversely, the control pulse PWM_R_R corresponds to the red color image signal written to the image forming devices 111A, 111B, and 111C for the right eye image display device. The control pulse PWM_G_R corresponds to the green color image signal written to the image forming devices 111A, 111B, and 111C for the right eye image display device. The control pulse PWM_B_R corresponds to the blue color image signal written to the image forming devices 111A, 111B, and 111C for the right eye image display device. The phase of the image signal and the control pulse is modulated by a phase modulation unit 84 configuring the pulse generating unit 83, and the width of the control pulse is modulated by a pulse width modulation unit 85 configuring the pulse generating unit 83. The obtained control pulses (control pulses for driving the 152 by PWM) PWM_R_L, PWM_G_L, PWM_B_L, PWM_R_R, PWM_G_R, and PWM_B_R are sent to the light source 152 (light sources 152_L and 152_R) via a PWM pulse output unit, and the light source 152 lights the image forming devices 111A, 111B, and 111C at a predetermined luminance. Instead of obtaining the field sequential information (FS information) from the second image signal processing circuit 62, the viewer may directly set the FS information, for example, by using a switch or resistor on the light source control unit 80.

The format of the input image signal is not limited to the RGB format, and so another format such as YUV may be used. In addition to the main signal processing for each color such as gamma correction and color correction performed at the first image signal processing circuit 61, other various processing (for example, color spot control processing or signal processing specific to liquid crystal display devices) may be performed, and the first image signal processing circuit 61 and the second image signal processing circuit 62 may be combined as one circuit. Gamma processing and so on, for example, may be performed by the second image signal processing circuit 62.

According to the example illustrated in FIG. 1A, the image display period during one display period is divided into an N number of image display sub-periods (specifically, N=3). Regarding an nth image display sub-period (where n is a value between 1 and N, including both 1 and N), the image display color when displaying the left eye image on the left eye image display device and the image display color when displaying the right eye image on the right eye image display device are different. Here, M=N=3 when M represents the number of multiple colors.

Conversely, according to the example illustrated in FIG. 2A, N=4, and M=3. Specifically, the image display period during one display period is divided into an N number of image display sub-periods (specifically, N=4). The red color image display and the blue color image display are both performed during one image display sub-period, and the green color image display is performed during two image display sub-periods.

Regarding the display device according to the first exemplary embodiment, the image display color when displaying the left eye image on the left eye image display device is different from the image display color when displaying the right eye image on the right eye image display device. Thus, even when the image may not be viewed for some reason during the period in which the image of one color is displayed during one display frame, the image color for the entire frame, or for the entire left eye image display device and the right eye image display device, that is supposed to be recognized is able to be recognized. That is to say, when the image display color of the left eye image is red and the image display color of the right eye image is green regarding FIGS. 1A and 2A, for example, and the viewer blinks or the eyeball moves suddenly causing the red color image for the left eye image and the green color image for the right eye image not to be seen (refer to FIGS. 1B and 2B), the viewer can recognize the red color image, the green color image, and the blue color image during one display frame for the entire left eye image and the right eye image (that is to say, the green color image and blue color image for the left eye image, and the blue color image and red color image for the right eye image can be recognized), which suppresses the occurrence of the color breakup phenomenon. That is to say, the prevention of missing specific colors regarding the entire image as recognized by the brain when the left eye image and the right eye image are combined is possible, which enables the resolution of the problem in which specific colors are completely unrecognized. At the same time, regarding the light source for the image display device according to the first exemplary embodiment, the timing to start light emission from the light source for the left eye image display device and the timing to start the light emission from the light source for the right eye image display device are different, so when the image may not be viewed for some reason during the period in which the image of one color is displayed during one display frame, the image color for the entire frame, or for the entire left eye image display device and the right eye image display device, that is supposed to be recognized is able to be recognized. That is to say, the occurrence of the color breakup phenomenon may be suppressed.

### Second Exemplary Embodiment

The second exemplary embodiment relates to the display device related to Embodiment 2 according to the present disclosure and the light source for the image display device according to the present disclosure, and specifically the display device related to Embodiment 2B according to the present disclosure and the second configuration of the light source for the image display device according to the present disclosure. Further, the display device and the image display device according to the second exemplary embodiment has the same configuration and construction as the display device and image display device described regarding the first exemplary embodiment, and so their detailed descriptions are omitted.

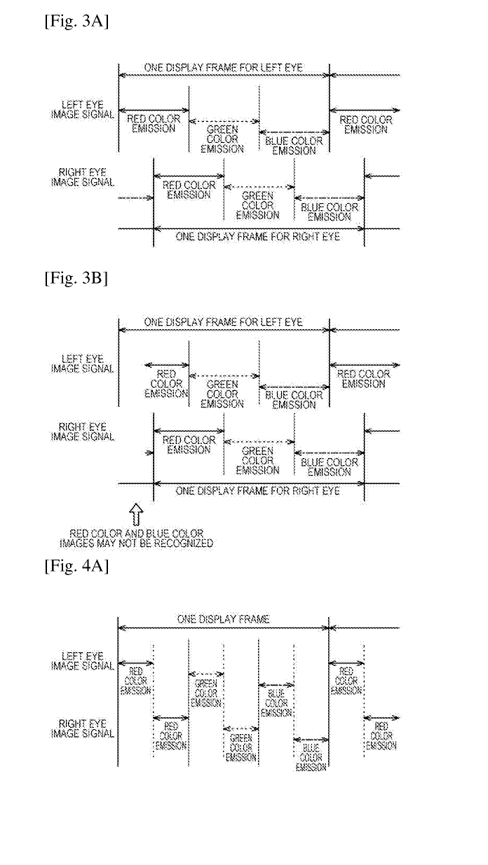

As illustrated by the schematics in FIGS. 3A and 4A of the image display state for the left eye image display device and the right eye image display device regarding the display device according to the second exemplary embodiment, the image display period when displaying the left eye image on the left eye image display device during one display frame (specifically, during one image display sub-period) and the image display period when displaying the right eye image on the right eye image display device during one display frame (more specifically, during the same image display sub-period) are different. Describing the display device according to Embodiment 2B of the present disclosure, the image display period during one display period in the display device according to the second exemplary embodiment is divided into an N number of image display sub-periods. Regarding an nth image display sub-period (where n is a value between 1 and N, including both 1 and N), the image display color when displaying the left eye image on the left eye image display device and the image display color when displaying the right eye image on the right eye image display device are the same, but the image display period during the nth image display sub-period is different.

Regarding the example illustrated in FIG. 3A, the image display period during the image display sub-period when displaying the left eye image on the left eye image display device during one image display sub-period and the image display period during the image display sub-period when displaying the right eye image on the right eye image display device overlap temporally. According to the example illustrated, this temporal overlap is 50% of one image display sub-period. According to the example illustrated in FIG. 4A, the image display period during the image display sub-period when displaying the left eye image on the left eye image display device and the image display period during the image display sub-period when displaying the right eye image on the right eye image display device during one image display sub-period has no temporal overlap.

Regarding the light source for the image display device according to the second exemplary embodiment, the period to start the light emission regarding the light source for the left eye image display device and the period to start the light emission regarding the light source for the right eye image display device are different. More specifically, the image display period during one display frame is divided into an N number image display sub-periods. Regarding an nth image display sub-period (where n is a value between 1 and N, including both 1 and N), the emitted color from the light source for the left eye image display device and the emitted color from the light source for the right eye image display device are the same, but the period to start the light emission regarding the light source for the left eye image display device and the period to start the light emission regarding the light source for the right eye image display device during an nth image display sub-period are different. Regarding the light source for the image display device according to the second exemplary embodiment, the light emission period of the light source for the left eye image display device and the light emission period of the light source for the right eye image display device during one image display sub-period has no temporal overlap (refer to FIG. 4A). Alternatively, the light emission period of the light source for the left eye image display device and the light emission period of the light source for the right eye image display device during one image display sub-period has a temporal overlap (refer to FIG. 3A).

Regarding such a display device according to the second exemplary embodiment, the memory control circuits 62B and 62C control the period in which the one display frame worth of red color image signals, green color image signals, and blue color image signals stored in the memory unit 64 are read so that the image display period when displaying the left eye image on the left eye display device during one display frame and the image display period when displaying the right eye image on the right eye image display device during one display frame are different. Specifically, the memory control circuits 62B and 62C change the timing that image signals are read between the left eye image display device and the right eye image display device when reading the red color image signal, the green color image signal, and the blue color image signal. The light source control unit 80 changes the phase of the image signals and the control pulses by the phase modulation unit 84. When the display sequence of the red color image, green color image, and the blue color image is the same for the left eye image display device and the right eye image display device, the light emission timing for the light sources 152R, 152G, and 152B can still be changed.

Regarding the image display device according to the second exemplary embodiment, the image display period when displaying the left eye image on the left eye image display device during one display frame and the image display period when displaying the right eye image on the right eye image display device during one display frame are different, and so even when an image may not be viewed during the period when the image of one color during one display frame is displaying (refer to FIGS. 3B and 4B), the image color for the entire frame, or for the entire left eye image display device and the right eye image display device, that is supposed to be recognized is able to be recognized. That is to say, the occurrence of the color breakup phenomenon may be suppressed. That is to say, the prevention of missing specific colors regarding the entire image as recognized by the brain when the left eye image and the right eye image are combined is possible, which enables the resolution of the problem in which specific colors are completely unrecognized. At the same time, regarding the light source for the image display device according to the second exemplary embodiment, the timing to start light emission from the light source for the left eye image display device and the timing to start the light emission from the light source for the right eye image display device are different, so when the image may not be viewed for some reason during the period in which the image of one color is displayed during one display frame, the image color for the entire frame, or for the entire left eye image display device and the right eye image display device, that is supposed to be recognized is able to be recognized. That is to say, the occurrence of the color breakup phenomenon may be suppressed.

The preferred embodiments of the present disclosure have thus been described, but the present disclosure is not limited to these embodiments. The configuration and construction of the display device (head-mounted display), image display device, and image forming device described in the embodiments are examples, and appropriate modifications may be made. For example, a front surface relief-type hologram may be arranged in the light guide board (refer to US Patent Application Publication No. 20040062505A1). Regarding the optical device 220, the diffraction grating element may be configured from a transparent-type diffraction grating element, or alternatively, either the first deflector or the second deflector may be configured from a reflecting-type diffraction grating element, and the other deflector may be configured from a transparent-type diffraction grating element. Alternatively, a reflecting-type blazed diffraction grating element may be used for the diffraction grating element. In the embodiments, the Y direction is a horizontal direction corresponding to the viewer, but the Y direction regarding the arrangement state of the image display device, image forming device, and the light guide unit may be a vertical direction corresponding to the viewer.

The image signal processing circuit 60 does not have to be configured in hardware physically connected (for example, a one-chip LSI), and may be configured as separate hardware (for example, multiple LSIs). In this case, the viewer may use a switch to directly write the FS information to a hardware register so that the image signals (information) for the left eye and the right eye are common between the left eye LSI and the right eye LSI. Regarding the time divisions of the field sequential drive signals according to the embodiments, N=3 or 4, but as this is not limited thusly, N may also equal six, for example. Specifically, the red color image display, the green color image display, and the blue color image display may be repeated two times during one display frame, for example. The viewer may store this setting in a register provisioned to the second image signal processing circuit 62, for example, using a switch, and the second image signal processing circuit 62 may perform processing on the basis of this setting information.

The present disclosure may have the following configurations.

(1) A display device, comprising:

a first image forming device configured to form a first color image by sequentially displaying a first plurality of single color images according to a first color sequence, wherein the first color sequence defines an order in which each of the first plurality of single color images is displayed, a start time for beginning to display the first plurality of single color images, and a duration over which each of the first plurality of single color images is displayed; and

a second image forming device configured to form a second color image by sequentially displaying a second plurality of single color images according to a second color sequence, wherein the second color sequence defines an order in which each of the second plurality of single color images is displayed, a start time for beginning to display the second plurality of single color images, and a duration over which each of the second plurality of single color images is displayed;
wherein the first color sequence is different from the second color sequence.

(2) The display device of (1), wherein the start time for beginning to display the first plurality of single color images is different from the start time for beginning to display the second plurality of single color images.

The display device of (2), wherein the order in which each of the first plurality of single color images is displayed is the same as the order in which each of the second plurality of single color images is displayed.

(4) The display device of (2), wherein the first image forming device is configured to display at least one of the first plurality of single color images when the second image forming device is not displaying any of the second plurality of single color images.

(5) The display device of (4), wherein there is no temporal overlap between a time when the first image forming device displays at least one of the first plurality of single color images a time when the second image forming device displays any of the second plurality of single color images.

(6) The display device of (2), wherein the first image forming device is configured to display at least one of the first plurality of single color images at the same time as the second image forming device is configured to display at least one of the second plurality of single color images such that there is a temporal overlap.

(7) The display device of (6), wherein the temporal overlap is within a range between 50 to 99 percent of a duration over which the at least one of the first plurality of single color images is displayed.

(8) The display device of (1), wherein:

a duration over which an image of a first color from the first plurality of single color images is displayed is different from a duration over which an image of a second color from the first plurality of single color images is displayed; and

a duration over which an image of the first color from the second plurality of single color images is displayed is different from a duration over which an image of the second color from the second plurality of second color images is displayed.

(9) The display device of (1), wherein:

the first image forming device is configured to form the first color image for display to a left eye of a viewer; and

the second image forming device is configured to form the second color image for display to a right eye of the viewer.

(10) The display device of (1), further comprising:

a frame configured to mount on the head of a viewer, wherein the first image forming device and the second image forming device are connected to the frame.

(11) The display device of (1), further comprising:

an image signal processing circuit configured to receive an image signal and convert the image signal into a field sequential drive signal for the first image forming device and a field sequential drive signal for the second image forming device.

(12) The display device of (11), wherein the image signal processing circuit comprises:
an image signal determination circuit configured to determine the first plurality of single color images and the second plurality of single color images from the received image signal.

(13) The display device of (11), further comprising:

at least one memory unit configured to store one display frame worth of field sequential drive signals.

(14) The display device of (1), wherein each of the first image forming device and the second image forming device comprises:
at least one light source configured to emit light of a plurality of colors; and

an intensity modulator configured to control the intensity of the light received by a viewer from the at least one light source.

(15) The display device of (12), wherein the intensity modulator comprises a liquid crystal device configured to control the transmission and/or reflection of the light emitted from the at least one light source.

(16) The display device of (12), wherein the intensity modulator comprises a plurality of digital micro-mirror devices configured to control reflection of the light emitted from the at least one light source.

(17) The display device of (1), further comprising:

a first optical device configured to guide an image from the first image forming device to a pupil of a viewer using total internal reflection; and

a second optical device configured to guide an image from the second image forming device to a pupil of the viewer using total internal reflection.

(18) The display device of (1), wherein the first plurality of single color images comprises a red image, a green image and a blue image.

(19) At least one light source for a display device, the at least one light source comprising:

a first light source configured to sequentially emit a first plurality of monochromatic light flashes according to a first color sequence, wherein the first color sequence defines an order in which the first plurality of monochromatic light flashes is emitted, a start time for beginning to emit the first plurality of monochromatic light flashes, and a duration over which each of the first plurality of monochromatic light flashes is emitted; and
a second light source configured to sequentially emit a second plurality of monochromatic light flashes according to a second color sequence, wherein the second color sequence defines an order in which the second plurality of monochromatic light flashes is emitted, a start time for beginning to emit the second plurality of monochromatic light flashes, and a duration over which each of the second plurality of monochromatic light flashes is emitted;
wherein the first color sequence is different from the second color sequence.

(20) A light source control circuit for controlling at least one light source of a display device, comprising:
a first pulse generation circuit configured to generate a first pulse sequence for controlling a first light source, wherein the first pulse sequence defines an order in which the first light source emits a first plurality of monochromatic light flashes, a start time for beginning to emit the first plurality of monochromatic light flashes, and a duration over which each of the first plurality of monochromatic light flashes is emitted; and

a second pulse generation circuit configured to generate a second pulse sequence for controlling a second light source, wherein the second pulse sequence defines an order in which the second light source emits a second plurality of monochromatic light flashes, a start time for beginning to emit the second plurality of monochromatic light flashes, and a duration over which each of the second plurality of monochromatic light flashes is emitted;

wherein the first pulse sequence is different from the second pulse sequence.

(21) A display device comprising:

a frame configured to mount on the head of a viewer; and

a left eye image display device and a right eye image display device installed to the frame;
wherein each image display device includes an image forming device configured to display images of a plurality of colors by the field sequential drive method;

and wherein an image display color when displaying a left eye image on the left eye image display device and an image display color when displaying a right eye image on the right eye image display device are different.

(22) A display device comprising:

a frame configured to mount on the head of a viewer; and

a left eye image display device and a right eye image display device installed to the frame;
wherein each image display device includes an image forming device configured to display images of a plurality of colors by the field sequential drive method;
and wherein an image display period when displaying a left eye image on the left eye image display device during one display frame and an image display period when displaying a right eye image on the right eye image display device during one display frame are different.

(23) The display device of (22),

wherein the image display period during one display frame is divided into an N number of image display sub-periods;

and wherein, regarding an nth image display period sub-frame (where n is a value between 1 and N, including both 1 and N), the image display color when displaying the left eye image on the left eye image display device and the image display color when displaying the right eye image on the right eye image display device are different.

(24) The display device of (22),

wherein the image display period during one display frame is divided into an N number of image display sub-periods;
and wherein, regarding an nth image display period sub-frame (where n is a value between 1 and N, including both 1 and N), the image display color when displaying the left eye image on the left eye image display device and the image display color when displaying the right eye image on the right eye image display device are the same, but the image display period during the nth image display sub-period is different.

(25) The display device of (24),

wherein the image display period regarding the image display sub-period when displaying a left eye image on the left eye image display device and the image display period regarding the image display sub-period when displaying the right eye image on the right eye image display device during one display sub-period have no temporal overlap.

(26) The display device of (24),

wherein the image display period regarding the image display sub-period when displaying a left eye image on the left eye image display device and the image display period regarding the image display sub-period when displaying the right eye image on the right eye image display device during one display sub-period have a temporal overlap.

(27) The display device of (26),

wherein the temporal overlap is within a range between 50 to 99% of one image display sub-period.

(28) The display device of (21), further comprising:

an image signal processing circuit configured to receive an image signal externally, conduct a predetermined signal processing on the image signal, and covert this to a field sequential drive signal.

(29) The display device of (28),

wherein the image signal processing circuit includes

a first image signal processing circuit configured to perform signal processing on image signals related to a plurality of colors,

a second image signal processing circuit configured to generate field sequential drive signals,

a third image signal processing circuit configured to perform signal processing on the field sequential drive signals for one display frame, and

a memory unit configured to store one display frame worth of field sequential drive signals.

(30) The display device of (29),

wherein the second image signal processing circuit includes

an image signal determination circuit configured to determine image signals related to a plurality of colors,

a memory interface between the memory unit, and

a memory control circuit configured to control the memory unit.

(31) The display device of (21),

wherein the image forming device includes

a light source configured to emit light of a plurality of colors, and

a liquid crystal display device configured to control the transmission and reflection of the light emitted from the light source.

(32) The display device of (21),

wherein the image forming device includes

a light source configured to emit light of a plurality of colors, and

a plurality of digital micro-mirror devices configured to control reflection of the light emitted from the light source.

(33) The display device of (21),

wherein each image display device further includes

an optical device configured to guide an image from the image forming device to a pupil of a viewer,

and wherein the optical device includes

a light guide board configured to propagate illuminated light to the interior by total reflection, and then emit this light,

a first deflector configured to deflect light illuminated onto the light guide board so that the light illuminated onto the light guide board is completely reflected to the interior of the light guide board, and

a second deflector configured to deflect, over a plurality of times, the light propagated to the interior of the light guide board by total reflection so that the light propagated to the interior of the light guide board by total reflection is emitted from the light guide board.

(34) The display device of (21),

wherein each image display device further includes

an optical device configured to guide an image from the image forming device to a pupil of a viewer,

and wherein the optical device includes

a reflecting mirror configured to reflect the image from the image forming device, and

a lens group configured to illuminate the image reflected by the reflecting mirror.

(35) A light source for an image display device comprising:

a light source for a left eye image display device provisioned to a left eye image display device; and

a light source for a right eye image display device provisioned to a right eye image display device;

wherein the light source for the left eye image display device and the light source for the right eye image display device emits light of a plurality of colors by the field sequential drive method so that images of a plurality of colors are displayed on the left eye image display device and the right eye image display device;

and wherein the period to start light emission regarding the light source for the left eye image display device and the period to start light emission regarding the light source for the right eye image display device are different.

(36) The display device of (35),

wherein the image display period during one display frame is divided into an N number of image display sub-periods,

and wherein, regarding an nth image display period sub-frame (where n is a value between 1 and N, including both 1 and N), the emitted color from the light source for the left eye image display device and the emitted color from the light source on the right eye image display device are different.

(37) The light source for the image display device of (35),

wherein the image display period during one display frame is divided into an N number of image display sub-periods,

and wherein, regarding an nth image display period sub-frame (where n is a value between 1 and N, including both 1 and N), the emitted color from the light source for the left eye image display device and the emitted color from the light source on the right eye image display device are the same, but the period to start light emission regarding the light source for the left eye image display device and the period to start light emission regarding the light source for the right eye image display device during the nth image display sub-period are different.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

10 frame
11 front portion
11′ center portion of the front portion
12 hinge
13 temple unit
14 drop end
15 wiring (signal wiring and power wiring)
16 earphone unit
16′ earphone wiring
17 image capturing device
18 control device (control circuit, control unit)
19 installation member
21 pupil of observer
100, 200, 300, 400, 500 image display device
111A, 111B, 111C, 111_R, 111_L image forming device
112 optical system (parallel light-emitting optical system, collimate optical system)
113 chassis
120, 220 optical device (light guide unit)
121, 221 light guide board
122, 222 first surface of light guide board
123, 223 second surface of light guide board
124 portion provisioned to the first deflector of the light guide board
125 portion provisioned to the second deflector of the light guide board
130 first deflector
140 second deflector
230 first deflector (first diffraction grating member)
240 second deflector (second diffraction grating member)
320 optical device (semi-transparent mirror)
321 transparent member
401 reflecting mirror
401, 402, 502 lens group
403, 404, 503 installation member
150A reflecting-type spatial light modulation device
150B transparent-type spatial light modulation device
151A, 151B liquid crystal display device (LCD)
152, 152R, 152G, 152B, 152_L, 152_R light source
153 polarizing beam splitter
154 digital micro-mirror device
155 reflecting mirror
60 image signal processing circuit
61 first image signal processing circuit
62 second image signal processing circuit
62A image signal determination circuit
62B, 62C memory control circuits (left eye image display device control circuit B and right eye image display device control circuit)
62D memory interface
62E FS output unit
63 third image signal processing circuit
64 memory unit
71 image signal input unit
80 light source control unit
81 FS information obtaining unit
82 synchronization signal input unit
83 pulse generating unit
84 phase modulation unit
85 pulse width modulation unit
86 PWM pulse output unit

1. A display device, comprising:
a first image forming device configured to form a first color image by sequentially displaying a first plurality of single color images according to a first color sequence, wherein the first color sequence defines an order in which each of the first plurality of single color images is displayed, a start time for beginning to display the first plurality of single color images, and a duration over which each of the first plurality of single color images is displayed; and
a second image forming device configured to form a second color image by sequentially displaying a second plurality of single color images according to a second color sequence, wherein the second color sequence defines an order in which each of the second plurality of single color images is displayed, a start time for beginning to display the second plurality of single color images, and a duration over which each of the second plurality of single color images is displayed;
wherein the first color sequence is different from the second color sequence.

2. The display device of claim 1, wherein the start time for beginning to display the first plurality of single color images is different from the start time for beginning to display the second plurality of single color images.

3. The display device of claim 2, wherein the order in which each of the first plurality of single color images is displayed is the same as the order in which each of the second plurality of single color images is displayed.

4. The display device of claim 2, wherein the first image forming device is configured to display at least one of the first plurality of single color images when the second image forming device is not displaying any of the second plurality of single color images.

5. The display device of claim 4, wherein there is no temporal overlap between a time when the first image forming device displays at least one of the first plurality of single color images and a time when the second image forming device displays any of the second plurality of single color images.

6. The display device of claim 2, wherein the first image forming device is configured to display at least one of the first plurality of single color images at the same time as the second image forming device is configured to display at least one of the second plurality of single color images such that there is a temporal overlap.

7. The display device of claim 6, wherein the temporal overlap is within a range between 50 to 99 percent of a duration over which the at least one of the first plurality of single color images is displayed.

8. The display device of claim 1, wherein:
a duration over which an image of a first color from the first plurality of single color images is displayed is different from a duration over which an image of a second color from the first plurality of single color images is displayed; and
a duration over which an image of the first color from the second plurality of single color images is displayed is different from a duration over which an image of the second color from the second plurality of second color images is displayed.

9. The display device of claim 1, wherein:
the first image forming device is configured to form the first color image for display to a left eye of a viewer; and
the second image forming device is configured to form the second color image for display to a right eye of the viewer.

10. The display device of claim 1, further comprising:
a frame configured to mount on the head of a viewer, wherein the first image forming device and the second image forming device are connected to the frame.

11. The display device of claim 1, further comprising:
an image signal processing circuit configured to receive an image signal and convert the image signal into a field sequential drive signal for the first image forming device and a field sequential drive signal for the second image forming device.

12. The display device of claim 11, wherein the image signal processing circuit comprises:
an image signal determination circuit configured to determine the first plurality of single color images and the second plurality of single color images from the received image signal.

13. The display device of claim 11, further comprising:
at least one memory unit configured to store one display frame worth of field sequential drive signals.

14. The display device of claim 1, wherein each of the first image forming device and the second image forming device comprises:
at least one light source configured to emit light of a plurality of colors; and
an intensity modulator configured to control the intensity of the light received by a viewer from the at least one light source.

15. The display device of claim 12, wherein the intensity modulator comprises a liquid crystal device configured to control the transmission and/or reflection of the light emitted from the at least one light source.

16. The display device of claim 12, wherein the intensity modulator comprises a plurality of digital micro-mirror devices configured to control reflection of the light emitted from the at least one light source.

17. The display device of claim 1, further comprising:
a first optical device configured to guide an image from the first image forming device to a pupil of a viewer using total internal reflection; and
a second optical device configured to guide an image from the second image forming device to a pupil of the viewer using total internal reflection.

18. The display device of claim 1, wherein the first plurality of single color images comprises a red image, a green image and a blue image.

19. At least one light source for a display device, the at least one light source comprising:
a first light source configured to sequentially emit a first plurality of monochromatic light flashes according to a first color sequence, wherein the first color sequence defines an order in which the first plurality of monochromatic light flashes is emitted, a start time for beginning to emit the first plurality of monochromatic light flashes, and a duration over which each of the first plurality of monochromatic light flashes is emitted; and
a second light source configured to sequentially emit a second plurality of monochromatic light flashes according to a second color sequence, wherein the second color sequence defines an order in which the second plurality of monochromatic light flashes is emitted, a start time for beginning to emit the second plurality of monochromatic light flashes, and a duration over which each of the second plurality of monochromatic light flashes is emitted;
wherein the first color sequence is different from the second color sequence.

20. A light source control circuit for controlling at least one light source of
a display device, comprising:
a first pulse generation circuit configured to generate a first pulse sequence for controlling a first light source, wherein the first pulse sequence defines an order in which the first light source emits a first plurality of monochromatic light flashes, a start time for beginning to emit the first plurality of monochromatic light flashes, and a duration over which each of the first plurality of monochromatic light flashes is emitted; and
a second pulse generation circuit configured to generate a second pulse sequence for controlling a second light source, wherein the second pulse sequence defines an order in which the second light source emits a second plurality of monochromatic light flashes, a start time for beginning to emit the second plurality of monochromatic light flashes, and a duration over which each of the second plurality of monochromatic light flashes is emitted;
wherein the first pulse sequence is different from the second pulse sequence.

21. A display device comprising:
a frame configured to mount on the head of a viewer; and
a left eye image display device and a right eye image display device installed to the frame;
wherein each image display device includes an image forming device configured to display images of a plurality of colors by the field sequential drive method;
and wherein an image display color when displaying a left eye image on the left eye image display device and an image display color when displaying a right eye image on the right eye image display device are different.

22. A display device comprising:
a frame configured to mount on the head of a viewer; and
a left eye image display device and a right eye image display device installed to the frame;
wherein each image display device includes an image forming device configured to display images of a plurality of colors by the field sequential drive method;
and wherein an image display period when displaying a left eye image on the left eye image display device during one display frame and an image display period when displaying a right eye image on the right eye image display device during one display frame are different.

23. The display device according to claim 22,
wherein the image display period during one display frame is divided into an N number of image display sub-periods;
and wherein, regarding an nth image display period sub-frame (where n is a value between 1 and N, including both 1 and N), the image display color when displaying the left eye image on the left eye image display device and the image display color when displaying the right eye image on the right eye image display device are different.

24. The display device according to claim 22,
wherein the image display period during one display frame is divided into an N number of image display sub-periods;
and wherein, regarding an nth image display period sub-frame (where n is a value between 1 and N, including both 1 and N), the image display color when displaying the left eye image on the left eye image display device and the image display color when displaying the right eye image on the right eye image display device are the same, but the image display period during the nth image display sub-period is different.

25. The display device according to claim 24,
wherein the image display period regarding the image display sub-period when displaying a left eye image on the left eye image display device and the image display period regarding the image display sub-period when displaying the right eye image on the right eye image display device during one display sub-period have no temporal overlap.

26. The display device according to claim 24,
wherein the image display period regarding the image display sub-period when displaying a left eye image on the left eye image display device and the image display period regarding the image display sub-period when displaying the right eye image on the right eye image display device during one display sub-period have a temporal overlap.

27. The display device according to claim 26,
wherein the temporal overlap is within a range between 50 to 99% of one image display sub-period.

28. The display device according to claim 21, further comprising:
an image signal processing circuit configured to receive an image signal externally, conduct a predetermined signal processing on the image signal, and covert this to a field sequential drive signal.

29. The display device according to claim 28,
wherein the image signal processing circuit includes
a first image signal processing circuit configured to perform signal processing on image signals related to a plurality of colors,
a second image signal processing circuit configured to generate field sequential drive signals,
a third image signal processing circuit configured to perform signal processing on the field sequential drive signals for one display frame, and
a memory unit configured to store one display frame worth of field sequential drive signals.

30. The display device according to claim 29,
wherein the second image signal processing circuit includes
an image signal determination circuit configured to determine image signals related to a plurality of colors,
a memory interface between the memory unit, and
a memory control circuit configured to control the memory unit.

31. The display device according to claim 21,
wherein the image forming device includes
a light source configured to emit light of a plurality of colors, and
a liquid crystal display device configured to control the transmission and reflection of the light emitted from the light source.

32. The display device according to claim 21,
wherein the image forming device includes
a light source configured to emit light of a plurality of colors, and
a plurality of digital micro-mirror devices configured to control reflection of the light emitted from the light source.

33. The display device according to claim 21,
wherein each image display device further includes
an optical device configured to guide an image from the image forming device to a pupil of a viewer,
and wherein the optical device includes
a light guide board configured to propagate illuminated light to the interior by total reflection, and then emit this light,
a first deflector configured to deflect light illuminated onto the light guide board so that the light illuminated onto the light guide board is completely reflected to the interior of the light guide board, and
a second deflector configured to deflect, over a plurality of times, the light propagated to the interior of the light guide board by total reflection so that the light propagated to the interior of the light guide board by total reflection is emitted from the light guide board.

34. The display device according to claim 21,
wherein each image display device further includes
an optical device configured to guide an image from the image forming device to a pupil of a viewer,
and wherein the optical device includes
a reflecting mirror configured to reflect the image from the image forming device, and
a lens group configured to illuminate the image reflected by the reflecting mirror.

35. A light source for an image display device comprising:
a light source for a left eye image display device provisioned to a left eye image display device; and
a light source for a right eye image display device provisioned to a right eye image display device;
wherein the light source for the left eye image display device and the light source for the right eye image display device emits light of a plurality of colors by the field sequential drive method so that images of a plurality of colors are displayed on the left eye image display device and the right eye image display device;
and wherein the period to start light emission regarding the light source for the left eye image display device and the period to start light emission regarding the light source for the right eye image display device are different.

36. The display device according to claim 35,
wherein the image display period during one display frame is divided into an N number of image display sub-periods,
and wherein, regarding an nth image display period sub-frame (where n is a value between 1 and N, including both 1 and N), the emitted color from the light source for the left eye image display device and the emitted color from the light source on the right eye image display device are different.

37. The light source for the image display device according to claim 35,
wherein the image display period during one display frame is divided into an N number of image display sub-periods,
and wherein, regarding an nth image display period sub-frame (where n is a value between 1 and N, including both 1 and N), the emitted color from the light source for the left eye image display device and the emitted color from the light source on the right eye image display device are the same, but the period to start light emission regarding the light source for the left eye image display device and the period to start light emission regarding the light source for the right eye image display device during the nth image display sub-period are different.
